(19) United States
(12) Patent Application Publication
(10) Pub. No.: US 2019/0235923 A1
(43) Pub. Date: Aug. 1, 2019

(54) Computational Assessment of a Real-World System and Allocation of Resources of the System

(71) Applicant: Connect Financial LLC, Wellesley, MA (US)

(72) Inventors: Sean Collins, Wellesley, MA (US); Charles F. Baker, IV, Brookline, MA (US); Martin Frenzel, Wayland, MA (US); Tak Wing Lau, Needham, MA (US); Rachael Thomas Acker, West Roxbury, MA (US); Joshua Matthew Eaker, West Roxbury, MA (US)

(73) Assignee: Connect Financial LLC, Wellesley, MA (US)

(21) Appl. No.: 15/886,535

(22) Filed: Feb. 1, 2018

(51) Int. Cl. G06F 9/50; G06F 9/48

(52) U.S. Cl. CPC G06F 9/5011; G06F 9/4881

(57) ABSTRACT

Among other things, there is coordination of the timing and execution (a) of allocations of amounts of real-world resources to competing uses of the resources, relative to (b) dynamic assessments of an overall state of a changing real-world system, in order to alter the overall state of the real-world system. A request is received for an allocation of an amount of a real-world resource of the real-world system to a particular use of the resource as of a particular allocation time. From time to time, information is ingested representing states of facets of the real-world system, to maintain the information current relative to the particular allocation time. A current overall state of the real-world system is dynamically assessed, based on the current information representing states of the facets of the real-world system, as of a time that is current relative to the particular allocation time. Based on the assessed current overall state of the real-world system and on the request for the allocation, and as of a time that is current relative to the particular allocation time, a determination is made of an amount of the real-world resource to allocate to the particular use of the resource. The allocation to the particular use is executed no later than the particular allocation time.

### BACKGROUND

This description relates to computational assessment of a real-world system and allocation of resources of the system.

### SUMMARY

In general in an aspect, an apparatus coordinates the timing and execution of (a) allocations of amounts of real-world resources to competing uses of the resources, relative to (b) dynamic assessments of an overall state of a changing real-world system, in order to alter the overall state of the real-world system. The apparatus includes computational components including an ingestion computational component, an assessment computational component, an allocation computational component, an execution computational component, and a coordination computational component. There is storage for instructions executable by the computational components to cause the coordination computational component to coordinate the timing and execution of (a) relative to (b) by doing at least the following: (c) receiving a request for an allocation of an amount of a real-world resource of the real-world system to a particular use of the resource as of a particular allocation time, (d) causing the ingestion computational component to ingest, from time to time, information representing states of facets of the real-world system, to maintain the information current relative to the particular allocation time, (e) causing the assessment computational component to dynamically assess a current overall state of the real-world system, based on the current information representing states of the facets of the real-world system, as of a time that is current relative to the particular allocation time, (f) causing the allocation computational component to determine, based on the assessed current overall state of the real-world system and on the request for the allocation, and as of a time that is current relative to the particular allocation time, an amount of the real-world resource to allocate to the particular use of the resource, and (g) causing the execution computational component to execute the allocation to the particular use no later than the particular allocation time.

Implementations may include one or a combination of two or more of the following features. The information ingested by the ingestion computational component includes values of state parameters. The computational components include a presentation component for providing an interactive user interface through a device of a user. The request for an allocation is received from a user through the interactive user interface. The request for an allocation is received automatically from a third-party. The request for an allocation received internally from one of the computational components. The instructions are executable to cause the presentation component to provide guidance to a user based on the assessed current overall state of the real-world system, the determined amount of the real-world resource to allocate, or the execution of the allocation. The execution computational component is caused to execute the allocation automatically. The execution computational component is caused to execute the allocation based on approval by a user. The computational components include an ontology computational component, and the instructions are executable to cause the ontology computational component to apply an ontology to the ingested information. The computational components include a moves computational component, and the instructions are executable to cause the moves computational component to determine one or more possible moves corresponding to one or more possible allocations. The computational components include a prioritization computational component, and the instructions are executable to cause the prioritization computational component to prioritize the possible moves. The particular allocation time includes a time in a periodic series of times. The particular allocation time includes a current time. The instructions are executable to cause the assessment computational component to assess the current overall state of the real-world system in real-time relative to the particular allocation time. The instructions are executable to cause the assessment computational component to assess the current overall state of the real-world system in real time as information is ingested by the ingestion computational component. The real-world system includes a financial domain of a user. The real-world resource includes a monetary resource. The use of the resource includes an investment. The use of the resource includes a purchase of a real-world product. The instructions are executable to cause the computational components to operate in accordance with fiduciary principles. The instructions are executable to cause the data ingestion component to receive the current values of the state parameters asynchronously to the assessment component assessing the current overall state of the real-world system. The instructions are executable to cause the assessment computational component to evaluate the current overall state of the real-world system automatically. The instructions are executable to cause the assessment computational component to assess current states of the respective facets of the real-world system. The instructions are executable to cause the assessment computational component to quantize the current states of each of the facets in a range of quantized buckets, and the instructions are executable by a presentation computational component to represent the current states of the facets through an interactive user interface of a device as metaphorical elements representing quantized current states of the respective buckets. The computational components include a filtering computational component, and the instructions are executable by the filtering computational component to select one or more moves from the possible moves. The values of the state parameters include values of transactions. The values of the state parameters include values of resources in accounts.

In general in an aspect, there is coordination of the timing and execution (a) of allocations of amounts of real-world resources to competing uses of the resources, relative to (b) dynamic assessments of an overall state of a changing real-world system, in order to alter the overall state of the real-world system. A request is received for an allocation of an amount of a real-world resource of the real-world system to a particular use of the resource as of a particular allocation time. From time to time, information is ingested representing states of facets of the real-world system, to maintain the information current relative to the particular allocation time. A current overall state of the real-world system is dynamically assessed, based on the current information representing states of the facets of the real-world system, as of a time that is current relative to the particular allocation time. Based on the assessed current overall state of the real-world system and on the request for the allocation, and as of a time that is current relative to the particular allocation time, a determination is made of an amount of the real-world resource to allocate to the particular use of the resource. The allocation to the particular use is executed no later than the particular allocation time.

In general in an aspect, an apparatus coordinates the interrelationship and timing of (a) dynamic assessments of an overall state of a changing real-world system with (b) interactions occurring at one or more interaction times through a user interface on a device of the user, in order to alter the overall state of the real-world system based on the user interactions. The apparatus includes computational components including an ingestion computational component, an assessment computational component, a presentation computational component, and a coordination computational component. There is storage for instructions executable by the computational components to cause the coordination computational component to coordinate the interrelationship of (a) with (b) by causing the following: (c) the ingestion computational component to ingest, at ingestion times, information representing states of facets of the real-world system, to maintain the information current relative to the times of interactions occurring through the user interface, (d) the assessment computational component to dynamically assess a current overall state of the real-world system, based on the current information representing states of the facets of the real-world system, as of one or more assessment times that are current relative to the times of the interactions occurring through the user interface, (e) causing the presentation computational component to engage in the interactions at the one or more interaction times by providing guidance representative of the assessed current overall state of the real-world system and receiving input associated with the assessed current overall state of the real-world system, (f) the assessment computational component to take account of received input in dynamically assessing the current overall state of the real-world system at assessment times that are subsequent to the interaction times, (g) causing the ingestion computational component to ingest the information at ingestion times that can be asynchronous relative to the assessment times and the presentation times.

Implementations may include one or a combination of two or more of the following features. The information ingested by the ingestion computational component includes values of state parameters. The values of the state parameters include values of transactions. The values of the state parameters include values of resources in accounts. The computational components include an ontology computational component, and the instructions are executable to cause the ontology computational component to apply an ontology to the ingested information. The instructions are executable to cause the assessment computational component to assess the current overall state of the real-world system in real time as information is ingested by the ingestion computational component. The real-world system includes a financial domain of a user. The instructions are executable to cause the ingestion computational component to ingest at least one of user supplied information, credit bureau information, or transaction data. The computational components include a segmentation computational component, and the instructions are executable to cause the segmentation computational component to segment information ingested by the ingestion computational component according to demographic characteristics. The computational components include a policy computational component, and the instructions are executable to cause the policy computational component to provide policy targets associated with respective facets of the real-world system. The instructions are executable to cause the assessment computational component to apply valuation functions for respective facets of the real-world system. The instructions are executable to cause the assessment computational component to determine progress metrics for respective facets of the real-world system. The instructions are executable to cause the assessment computational component to dynamically assess current states of respective facets of the real-world system. The instructions are executable to cause the assessment computational component to dynamically assess the current overall state of the real-world system by weighting dynamic assessments of current states of respective facets. The instructions are executable to cause the assessment computational component to derive relative assessment values for the current overall state of the real-world system or for the current states of respective facets. The instructions are executable to cause the computational components to do one or a combination of two or more of the following: perform allocations of resources available in the real-world system, prioritize allocations of resources, or provide interactions through the user interface. The instructions are executable by the presentation computational component to represent states of respective facets of the real-world system by interactions that include metaphorical elements. The instructions are executable to cause the assessment computational component to quantize the current states of each of the facets in a range of quantized buckets, and to cause the presentation computational component to provide interactions that include metaphorical elements that correspond to the quantized buckets. The metaphorical elements include suites of related graphical elements portrayed in successive states and the successive states correspond to the respective quantized buckets. The computational components include a prioritization computational component, and the instructions are executable to cause the prioritization computational component to prioritize possible moves associated with the current overall state of the real-world system. The computational components include a presentation computational component, and the instructions are executable to cause the presentation computational component to provide interactions that graphically illustrate the prioritization of the possible moves. The instructions are executable to cause the presentation computational component to provide interactions that graphically illustrate changes in the prioritization of the possible moves. The computational components include a presentation computational component to provide interactions that include financial guidance to a user.

In general in an aspect, there is a coordination of the interrelationship and timing of (a) dynamic assessments of an overall state of a changing real-world system with (b) interactions occurring at one or more interaction times through a user interface on a device of the user, in order to alter the overall state of the real-world system based on the user interactions. At ingestion times, information is ingested representing states of facets of the real-world system, to maintain the information current relative to the times of interactions occurring through the user interface. A current overall state of the real-world system is dynamically assessed, based on the current information representing states of the facets of the real-world system, as of one or more assessment times that are current relative to the times of the interactions occurring through the user interface. The interactions are engaged in at the one or more interaction times by providing guidance representative of the assessed current overall state of the real-world system and receiving input associated with the assessed current overall state of the real-world system, taking account of received input in dynamically assessing the current overall state of the real-world system at assessment times that are subsequent to the interaction times. The information is ingested at ingestion times that can be asynchronous relative to the assessment times and the presentation times.

In general in an aspect, an apparatus coordinates the timing and execution of (a) determinations of particular amounts of monetary assets to be invested in a 401(k) or other investment plan at particular investment times in view of an overall state of a financial domain of the participant in the plan, relative to (b) executions of investments of the particular amounts of monetary assets in the 401(k) or other investment plan. The apparatus includes computational components including an assessment computational component, and allocation computational component, and execution computational component, and a coordination computational component. There is storage for instructions executable by the computational components to cause the coordination computational component to coordinate the timing and execution of (a) relative to (b) by the following: (c) causing the assessment computational component to dynamically assess the current overall state of the participant's financial domain as of a time or times that are current relative to the particular investment times, (d) causing the allocation computational component to determine, based on the assessed current overall state of the participant's financial domain, and as of the time or times that are current relative to the particular investment times, one or more allocations of the particular amounts, and (e) causing the execution computational component to execute the allocations to the 401(k) or other investment plan no later than the particular investment times.

Implementations may include one or a combination of two or more of the following features. The instructions are executable to cause the assessment computational component to base the dynamic assessment on current values of one or a combination of two or more of the following facets of the participant's financial domain: savings, investments, income, liabilities, or expenses of the participant. The instructions are executable to cause the allocation computational component to base the determined allocation on income earned by the person as an employee of a sponsor of the 401(k) or other investment plan. The instructions are executable to cause each of the allocations to relate to a single monthly payment to the 401(k) or other investment plan. The instructions are executable to cause the time or times of the allocations to include periodic times during a calendar year, and the allocations for the respective times are determined for a given year are not all the same amount. The instructions are executable to cause the execution computational component to execute the allocations by electronic funds transfer to a computational system of a manager of the 401(k) or other investment plan. The computational components include a presentation computational component, and the instructions are executable by the presentation computational component to cause presentation, through a user interface of a device, of information about at least one of: a proposed allocation, a request for approval of a proposed allocation, or a confirmation of an execution of a proposed allocation.

In general in an aspect, a method includes a computational system receiving electronically through a communication network an indication of an upcoming transfer time for an electronic transfer of a specific allocation of funds from a source electronic device holding funds of a party through a communication network to a target electronic device holding funds of an investment vehicle as an agent for the party. At the computational system, at a succession of times that are asynchronous to the upcoming transfer time, data is accumulated electronically through a communication network, representing one or more current parameters of a changing holistic condition that spans multiple facets of a financial domain of the party. At the computational system, at a time prior to the upcoming transfer time, (a) an assessment algorithm is applied to a set of parameters including the one or more current parameters to determine a current holistic condition of the financial domain of the party, and (b) based on the current holistic condition, an allocation algorithm is applied to determine the specific allocation of funds to be transferred as of the upcoming transfer time. The computational system may present to the party through a user interface of an electronic device, information about the specific allocation of funds to be transferred as of the upcoming transfer time or given prior approval of the user, no notification of the transfer may be required. After the presentation to the party and before the upcoming transfer time, the computational system triggers the electronic transfer of the specific allocation of funds from the source electronic device through a communication network to the target electronic device. At the computational system a confirmation of the electronic transfer is received. The computational system causes the presentation to the party through a user interface of an electronic device a confirmation of the electronic transfer. After the electronic transfer, the computational system continues to accumulate electronically through a communication network, data representing one or more current parameters of the changing holistic condition that spans multiple facets of a financial domain of the party.

Implementations may include one or a combination of two or more of the following features. With permission of the party, the computational system obtains permissioned data representing one or more current parameters. The computational system receives from the party, through a user interface of an electronic device, preferences about allocation of funds.

These and other aspects, features, and implementations will become apparent from the following descriptions, including the claims and can be expressed as methods, apparatus, systems, components, program products, methods of doing business, means or steps for performing a function, and in other ways.

### DESCRIPTION

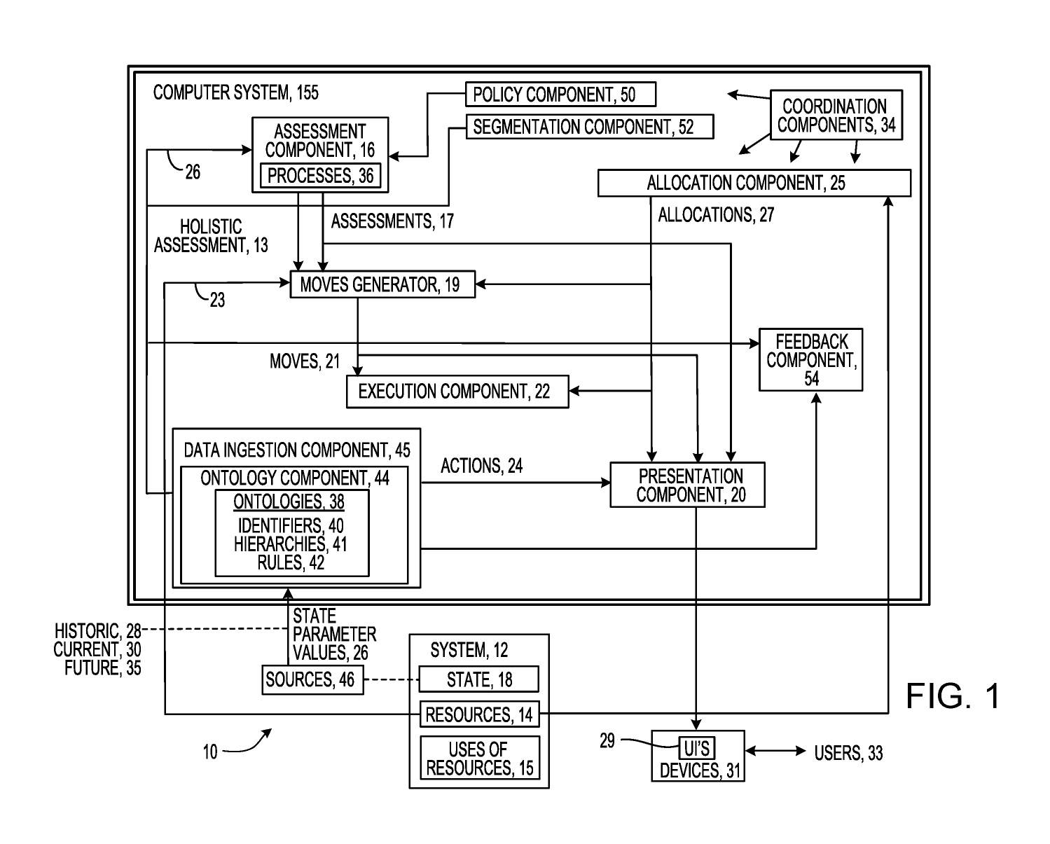

FIGS. 1 3, 8, 9, 10, and 11 are block diagrams.

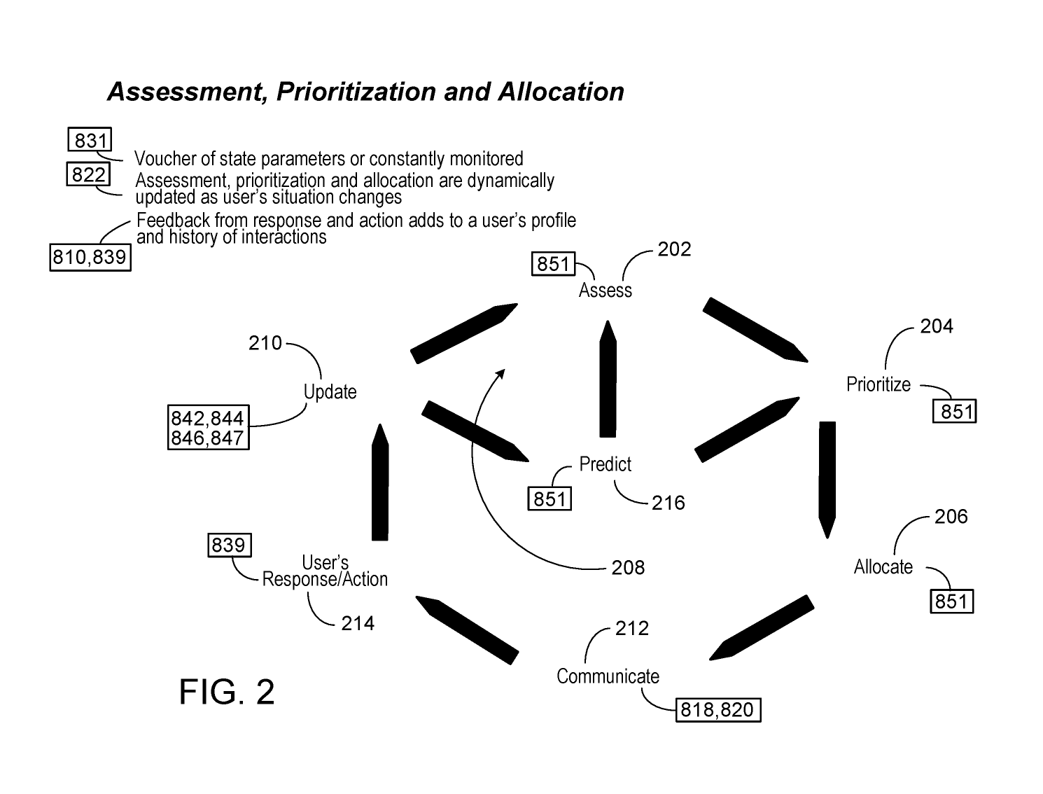

FIGS. 2, 4, 5, and 6 are schematic diagrams.

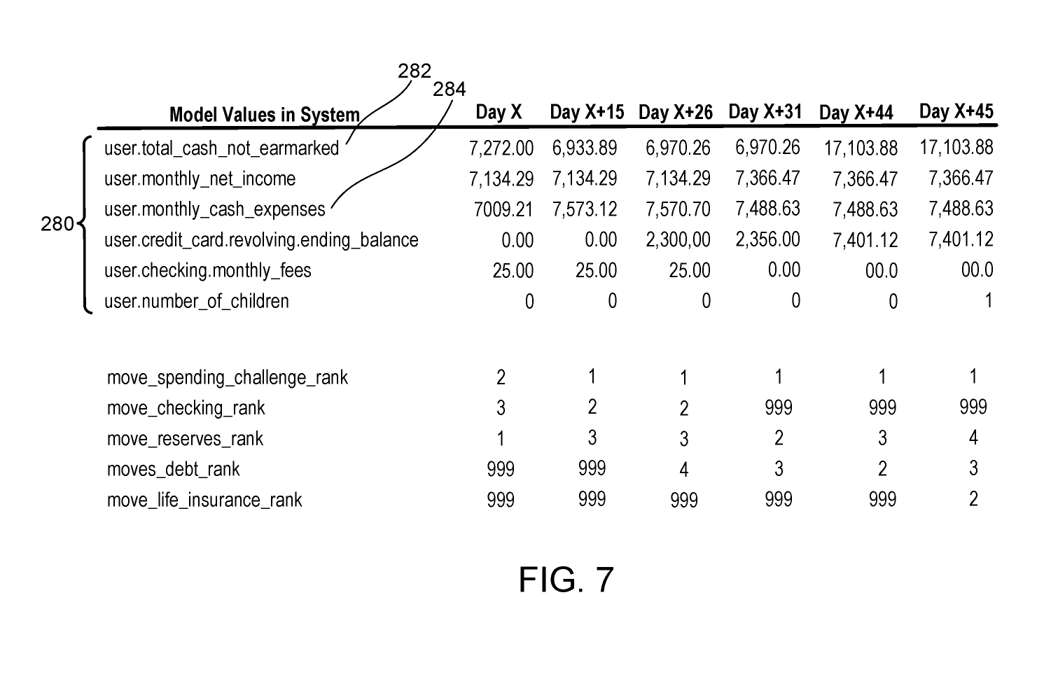

FIG. 7 is a table.

### OVERVIEW

As shown in FIG. 1, we describe a computational technology 10 that can measure or otherwise assess an overall state 18 or states of facets of a system 12 (for example, a real-world system such as a personal financial domain of a consumer), identify actions (e.g., moves) to take or consider taking based on the measurement or other assessment, prioritize the possible moves, and allocate system resources 14 to competing uses of resources 15, in order to improve the overall state or states of facets of the system.

We use the term “real-world system” broadly to include, for example, any arrangement, composition, organization, combination, structure, or assembly of elements or components that operate or are present in the physical realm.

We use the term “facet” broadly to include, for example, any feature, aspect, component, or constituent, such as, the credit card debt, life insurance, expense budget, and other facets of a personal financial domain.

We use the term “move” broadly to include, for example, any action, activity, event, strategy, tactic, suggestion or other occurrence that may affect the state of a real-world system, such as the financial domain of a person, such as payments, plans for payments, recommendations for product purchases, or behavioral financial assistance, to name a few. Moves can be implemented by actions.

To perform these tasks, the computational technology 10 can be implemented, for example, on a computer system 155 (using hardware, software, of combinations of them) that includes computational components. Each of the computational components, including the ones described below, can be implemented as a software module, a software object, code, firmware, or hardware or combinations of them. The computational components can interact by any of the interaction methods used by components in computer systems.

An assessment component 16 provides data-driven, dynamic, accurate, and effective assessments 17 of the state 18 of one or more facets of (or, for example, a holistic or overall assessment 13 of a full set of the facets of) the real-world system. An allocation component 25 proposes or effectuates (or both) one or more allocations 27 of available-to-be-allocated resources of the system to competing uses of resources based on results provided by the assessment component, among other things. A moves generator 19 dynamically formulates possible moves 21 based on the results of the assessments and on information 23 about available resources and other aspects of the system and on proposed allocations 27 generated by the allocation component 25. The moves can be prioritized based on one or more factors.

One or more execution components 22 cause or enable actions 24 (such as executions of allocations) to alter the states of facets of the system based on possible moves generated by the moves generator. The goal of the actions, for example, is to improve the states or to prevent a decline of the states of one or more facets of the system. A presentation component 20 presents one or more aspects of or results of the assessments, the allocations, the executions, or combinations of them, for example, to users 33 through user interfaces 29 of devices 31. The presentations include graphical and other features that make them easy to process, intuitive, and effective in educating and motivating a user and effective in directing a user to take on and follow through recommended actions.

A coordination component 34 coordinates the timing and execution of the activities of other components of the system, including an ingestion component, an ontology component, the assessment component, the allocation component, the execution component, a policy component, a segmentation component, a feedback component, and the presentation component, among others.

The states of one or more of the facets of (and the overall, holistic state of) the real-world system depend on or are otherwise characterized based on values of one or more state parameters 26. The values can include historic state parameter values 28, current state parameter values 30, and future (e.g., predicted) state parameter values 35, or combinations of them. The assessment component assesses the states of the facets (and combinations of them) of the system by processing the state parameter values 26 using one or more assessment processes 36.

To facilitate the processing by the assessment component, in some implementations the state parameters are expressed and organized according to one or more ontologies 38. Each of the ontologies can define identifiers 40 of various state parameters, hierarchies 41 of the parameters, and rules 42 for expressing them in a canonical form that the assessment component (and other components) expect or can use. Each ontology can be implemented by an ontology component 44 that can accept the values of state parameters from external sources 46 and map or otherwise convert them from their native forms and identifiers to the canonical form. The use of such ontologies reduces the time to generate and improves the quality of assessments and actions and moves based on them and facilitates the ingestion of data and information by the computational technology. Examples of such ontologies are described in U.S. patent application Ser. No. 15/593,870, filed on May 12, 2017, and incorporated here in its entirety by reference.

The ontology component 44 can be part of or associated with a data ingestion component 45 for generally ingesting (e.g., monitoring and acquiring) external data (for example, continuously or periodically or occasionally or on demand) for use in the (e.g., dynamic) assessment of the states of facets of or the holistic whole of the system. Dynamic assessment can include, for instance, real-time assessment as external data changes. Real-time assessment can enable real-time or on time or on demand selection and implementation of moves and actions.

The ways in which the real-world system operates with real-world resources or interacts with the surrounding world can be characterized by two or more conceptual dimensions. These dimensions imply trade-offs between competing financial and non-financial priorities. As an example, there are trade-offs among adding to a debt balance versus contributing to a 401(k) plan versus going on vacation. Each use of resources has merit, provides utility and has a near-term or long-term payoff. The computational technology resolves these trade-offs. In addition, the real-world system can also be characterized by temporal stages corresponding to successive time periods; in each of the temporal stages, the real-world system can have qualities particularly associated with that corresponding time period. Temporal sense can complicate or at least augment both the valuation of each individual conceptual dimension and the tradeoff between dimensions. As the evolutionary state of the real-world system changes—for example, the user progresses from single to married or from working to retired, the best prioritization and allocations may differ and may be in direct conflict. Academic grounding for the shifting in priorities and subsidy from one temporal stage to support another temporal stage can be found in the “permanent income hypothesis” and other life stage theories. The computational technology will address these competing needs and optimize while reducing behavioral biases the current state of the real-world system may have over its likely or possible future state.

In addition to the components described above, the computational technology can include a policy component 50 for storing values representing policy targets. The policy targets can define goals for values or changes in values of state parameters and can be used by the assessment component. The computational technology can include a segmentation component 52 to segment users based on demographic information associated with the state parameter values 26; and a feedback component 54 to receive system parameter values resulting from implementations of system actions, to process the values, and to provide feedback to the assessment component.

In some implementations, the computational technology segments users according to three dimensions:

(1) Age (broken into age groups: under 30, 31-40, 41-50, 51-60, and above 60)

(2) Homeownership (TRUE or FALSE)

(3) Status of having children (TRUE or FALSE)

As a result, in some implementations, there can be 5×2×2=20 segments defined in the segmentation model. Additional dimensions for segmentation will be added.

In some implementations, the computational technology confirms with a user if any system action (or actions) had been adopted (for example, if the user bought an insurance policy identified by the system). In the user interface, the confirmation can be produced by clicking a button (or buttons) on screen. This information is stored in the system and can be used for future assessments. Actual observation of an action's expected consequence may be needed.

Meanwhile, in some implementations, if a system action has been suggested but the user has not yet responded by taking any actions, a lock period is generated so that the same action will not be presented repeatedly, and the system will also be prevented from showing any additional and potentially incoherent actions (which may depend on the completion of the first action). In some implementations, a lock is imposed only after the user actually responds indicating the user is (or is not) going to take action.

For example, if the model had determined that a user needed life insurance and had sufficient cash flow to pay for the required insurance premium, and if the user took the advice to obtain life insurance, then the system would expect to see a certain insurance premium deducted as a recurring expense from the incoming transaction details. This new value would in turn be processed, which then updates the corresponding model inputs for the newly acquired insurance coverage. Any previous non-zero insurance coverage gap would then be refreshed.

The real-world system resources 14 may be generated or received as a result of system moves or actions or other occurrences in the outside world. The resources can be stored temporarily or over a period of time and may grow or decline over time. At a given time, one or more resources may be available to be devoted to a move or action and, in turn, to one or more uses of resources. At times a resource may not be available. When available, a resource may be applied (by allocations and moves) to uses of resources associated with one or more facets of the real-world system to affect its state, for example, to improve its state or prevent its state from declining. The resources may be allocated to various facets of the real-world system based, for example, on resource allocations suggested or effected by the allocation component.

Because the computational technology can operate dynamically, in real time, assessments of the state of the real-world system and allocations of resources based on the assessments can be effectuated and reported to the user currently and accurately at any time.

We use the term “dynamic” broadly in reference to an activity, action, event, or other occurrence, to indicate, for example, that the occurrence happens in real-time, currently, in response to a change that will affect the occurrence, or essentially without delay, among other things.

In some implementations, the assessment component uses a statistical assessment model that is based on values of a broad range of state parameters applicable to the real-world system. In some cases, the statistical assessment model takes account of all such state parameters, or all significant such state parameters. The statistical assessment model can be an optimization model that optimizes an overall holistic state of the real-world system based on the values of the state parameters.

The statistical assessment model is built on key factors pertinent to an individual's financial state across multiple dimensions or facets. These factors, captured in state parameters, can be quantitative or qualitative, and may include one or more of, but not be limited to, the following: liquidity level; other tradable, illiquid or tax-sheltered assets; savings habits; consumption level; consumption mechanism (payment tender); debit-to-income ratio (front- and back-end); debt payment dynamics; credit scores; death benefits for beneficiaries; tail risk hedging for physical and financial assets.

In some cases, the assessment model aims at limiting overall multi-dimensional risk exposures (e.g. debt, lack of savings, etc.) that could negatively impact an individual's financial state. Optimization algorithms are employed to provide the real-world system with a set of functional targets and measurements for improving the state of the person's financial domain.

For example, a functional debt-to-income ratio helps an individual monitor the level of leverage such that the total interest costs and the total time to pay-off debt would not become unduly burdensome in the near-term, or risk spiraling into personal bankruptcy in the long run. The determination of debt-to-income ratio, from a personal finance perspective, is more complicated because it is necessary to balance other factors in addition to debt, such as insufficient level of liquid assets and cash flow constraints.

In some instances, the model aims at balancing the needs across liquidity, debt burden, consumption, and life insurance facets. In some examples, the models can expand to other needs such as goal-based savings.

Optimization techniques may involve logistic regression, Monte-Carlo simulation, decision trees as well as other econometric and machine learning methodologies. Whenever appropriate, heuristics, industry rule-of-thumbs and expert judgments are also employed in achieving good model performance.

### Assessment, Prioritization, and Allocation

In some implementations, the computational technology that we describe here performs certain activities in three stages—assessment, prioritization, and allocation—using, for example, the components described above.

Thus, as shown in FIG. 2, among other things, the computational technology provides components configured to assess 202 the state of one or more or all of the facets of a system, prioritize 204 possible moves or actions aimed at improving or otherwise changing the state of the system, and determine and effect allocations 206 of resources of the system to implement the possible moves or actions.

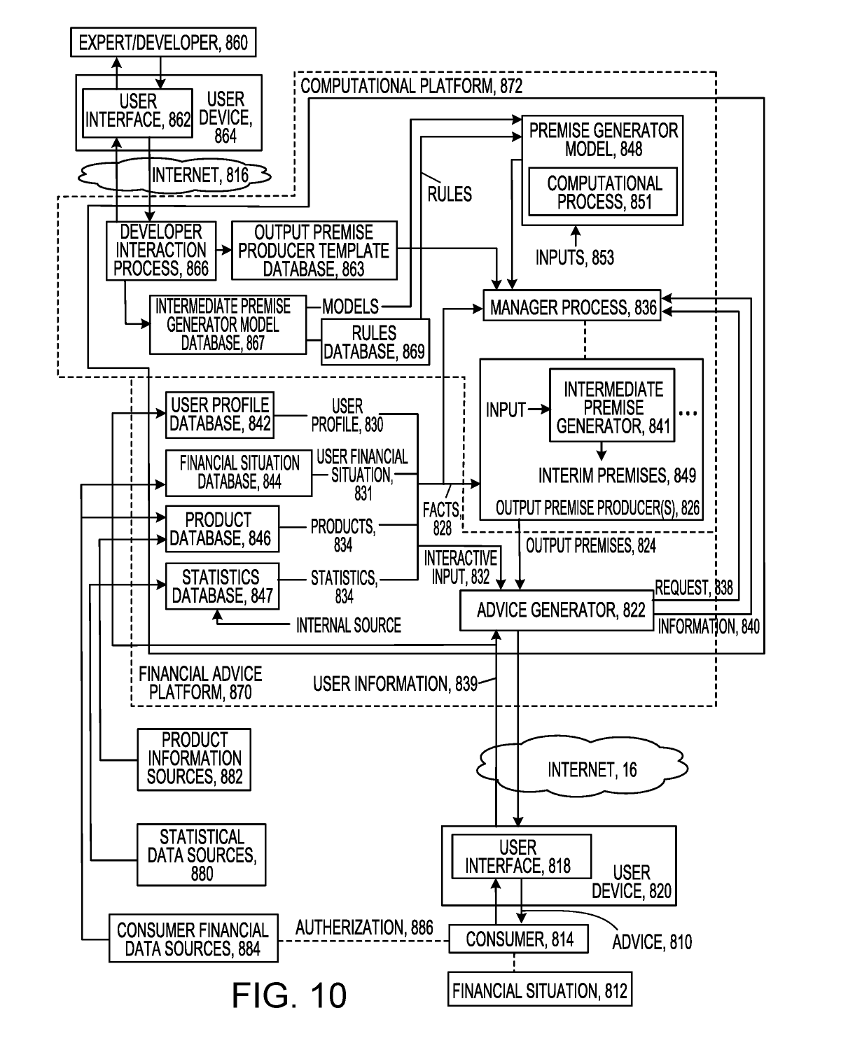

In FIGS. 2, 4, 5, and 6, certain annotations are shown in boxes containing numerical values, such as “839”. Each of these is associated with a corresponding implementation element or elements shown by corresponding numbers in FIG. 10.

The computational technology can perform a loop 208 of activities using a corresponding set of computational components. For purposes of discussion, the loop can begin with the updating 210 of the values of state parameters 212 by ingesting those values from outside sources and receiving values determined internally by the components of the computational technology. Once the values are updated, the facets of the state of the financial domain of the user are assessed 202. The assessments can also be based on predictions 216 of future values that are based on the updated current values of state parameters.

Possible predictions include the time expected to pay off one's existing debt, the estimated total interest costs, the trend of credit card balance reduction or accumulation, the timing of recurring or seasonal expenses, the probability of running out of liquid cash, and others. These predictions are based on observable history from a user's past transactions, credit score attributes, other user-supplied information, and behavior of other users.

The assessments and predictions are both used to prioritize 204 one or more potential moves or corresponding actions intended to improve or otherwise affect the state of the system. The assessments can apply not only to the overall (holistic) state of the system, but also to one or more facets of the system. The assessments can involve computing the assessment values based on state parameters and predictions, and the prioritization can involve ranking or scoring some or all of the potential actions based, for example, on the assessment values.

Each of the potential moves or actions that are ranked by the prioritization can lead to an allocation or proposed allocation 206 of a resource of the system to a use of a resource. The allocation activity can involve effecting the allocation automatically (without further human approval) or advising a person about possible allocations or both. In some cases, the possible allocations and the rankings of the corresponding moves or actions can be communicated 212 to the user either to seek the user's approval (in which case the allocation can then be effected by the computational technology) or to encourage the user to perform the allocation or take the move or action herself.

In any case, if the user acts on the suggestion or approves the action or allocation by the computational technology or if the move is performed automatically, the values of state parameters will then be affected, leading to a next iteration of the updating to 210, and so on. Feedback from the user's responses and actions are added to a user's profile and history of interactions for later use.

In some cases, the updating 210 as well as the assessment, prioritization and allocation all can be repeated dynamically (e.g., in real time) as the values of the underlying state parameters change, or can be triggered at periodic times, or at particular selected times.

### Personal Finance Domain Example

In our discussion, we sometimes use, as an example of a real-world system to be assessed (e.g., dynamically and holistically) and whose resources are to be allocated (e.g., dynamically), a suite of financially-related features, products, devices, information, states, activities, and resources that together make up what we call a person's financial domain (i.e., the person's financial system, a real-world system) or facets of the person's financial domain. Nevertheless, the computational technology that we describe here also can be used for a wide variety of other real-world systems, including systems that do, and systems that do not, directly relate to domains of people.

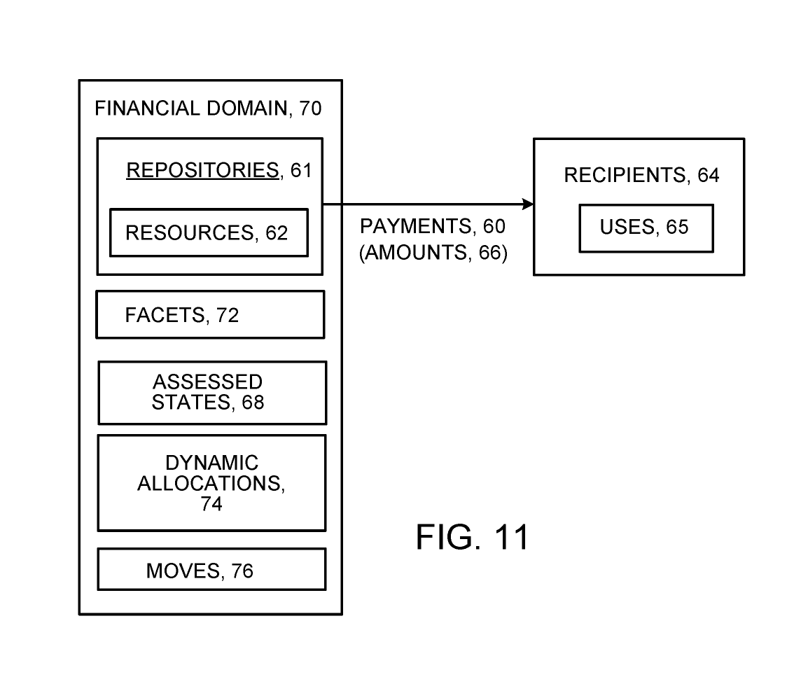

As shown in FIG. 11, in some examples of dynamic allocation of resources, one or more payments 60 are to be made from one or more repositories 61 of a person's resources 62 to one or more recipients 64 for one or more uses of resources for the benefit of the person. The amounts 66 of the payments may not be fixed but rather may vary depending on assessed states 68 of the person's financial domain 70 at some point in time, for example, as of the time when the payment is to be made. The computational technology that we describe here can dynamically assess states of the person's financial domain or facets 72 of the domain as of that point in time and then propose a dynamic allocation 74 of resources and moves 76 to implement the allocation, for instance, by paying one or more amounts based on the result of the dynamic assessment.

Implementation of the example illustrated in FIG. 11 can be accomplished using the computer system and components illustrated in FIG. 1, for example. A wide variety of other technology implementations would also be possible.

### Assessment

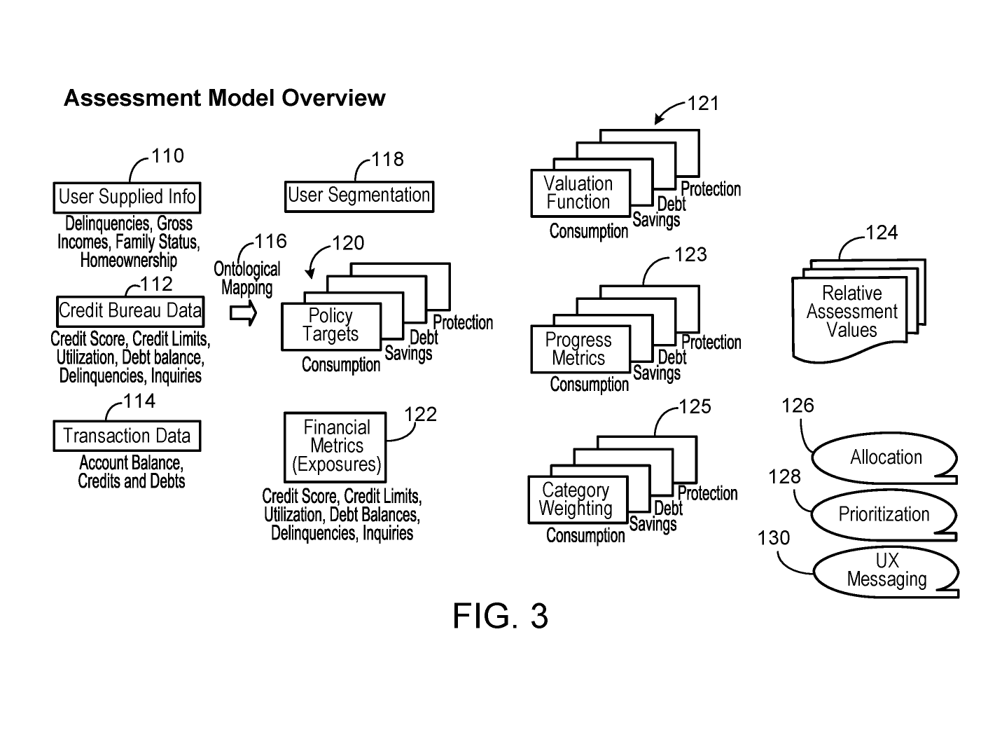

Using the financial domain of a person as an example, as shown in FIG. 3, the assessment stage performed by the assessment component provides evaluations of the states of one or more facets (or all of the facets holistically) of the real-world system (e.g. the financial domain) and operates in four steps represented by the activities shown respectively in the four columns of the figure.

The first column on the left applies to the first stage in which information is acquired as the basis for the assessment. The first column shows sources of information for the assessment process, including values of state parameters represented by user supplied information 110 (such as demographics, gross income, family status, and homeownership including non-numerical information); credit bureau data 112 (such as a credit score, credit limits, utilization of credit, debit balances, delinquencies, and debt inquiries); and transaction data 114 (such as account balances, credits, and debits). When the values of state parameters are ingested, they undergo an ontological mapping 116 so that they can be used consistently by internal processes of the computational technology.

At the second stage (illustrated in the second column), the assessment process of the assessment component performs user segmentation 118. Segmentation includes classifying a user based on demographic information. In some implementations, a segmentation captures the primary dimensions of financial situations and temporal stages. For example, a user may be segmented based on age (or age group), gender, geographic location (city and zip code), homeowner status, and family status (with or without children), property types and values, income level, occupation, and tenure. For a life insurance facet, segmentation can include tobacco use status or other health factors.

In addition to classifying the user in a segment, the second stage of the assessment process receives, creates, and maintains policy targets 120 in each of, in this example, several financial facets (consumption, savings, debt, protection, insurance (not shown)). The policy targets can be phrased manually by the developer of the assessment component and may be altered if new user-supplied information is received. The policy targets influence how the user is viewed by the assessment process and are applied to the state parameters for various purposes described below. The policy targets are also subject to periodic review according to changes in the macroeconomic environment, for example.

Examples of policy targets include: (1) for credit card debt, a current credit card debt policy is based on a percentage of gross income spent on servicing the required minimum payments, (2) for protection, a current life insurance policy takes into account income replacement, children's education costs, financial obligations (such as mortgage balance), and post-death expenses (such as typical funeral costs), (3) for savings, a current liquid savings policy (for rainy day fund) varies according to a user's age (or age group), homeowner status, and family status (with or without children), (4) for consumption, a current consumption policy measures in percentage terms a user's consumption flow with respect to gross income, (5) for overall debt, a policy considers an overall debt burden (student debt, auto loans), semi-liquid to illiquid assets, and additional financial obligations such as auto insurance, (6) an estimated budget policy is based on consumption at different points in a user's spending cycle/calendar months, and (7) policies based on accrual and other goal-based targets.

The assessment process of the assessment component also collects, generates, and maintains measurement tools (e.g., financial metrics 122) that represent potential risks or exposures and potential upsides implied by the state of the system. The financial metrics can be based on values derived from a cohort of users and the choice of metrics may include non-quantitative considerations. The financial metrics can include measures of credit scores, credit limits, utilization of credit, debt balances, delinquencies, and credit inquiries, among others.

At the third stage (illustrated in the third column), the assessment component uses the segmentation determination, applicable policy targets, and financial metrics to assess the state of the user's financial domain (holistically) or facets of it. The assessment component applies algorithmic valuation functions 121 for each of the financial facets. Among other things, the valuation functions can determine the degree of disparity between policy targets and current values of state parameters. For example, the valuation function for consumption could compare current spending with future targeted spending. The assessment component also computes progress metrics 123 for each of the facets over time based on values of state parameters as time passes.

For the purpose of illustration, we use an example from the facet of savings (liquid cash) from one implemented version of a model.

As seen in the following table, the target number of months for savings (rightmost column) depends on the segmentation of age group, status of having dependents, and home ownership.

| Age | | | |
|---|---|---|---|
| Group | Dependent | HomeOwn | Savings |
| 30 | TRUE | TRUE | 4 |
| 30 | TRUE | FALSE | 3 |
| 30 | FALSE | TRUE | 2.5 |
| 30 | FALSE | FALSE | 2 |
| 40 | TRUE | TRUE | 4 |
| 40 | TRUE | FALSE | 3 |
| 40 | FALSE | TRUE | 3 |
| 40 | FALSE | FALSE | 3 |
| 50 | TRUE | TRUE | 4 |
| 50 | TRUE | FALSE | 3 |
| 50 | FALSE | TRUE | 3 |
| 50 | FALSE | FALSE | 3 |
| 60 | TRUE | TRUE | 4 |
| 60 | TRUE | FALSE | 3.5 |
| 60 | FALSE | TRUE | 3.5 |
| 60 | FALSE | FALSE | 3.5 |
| 70 | TRUE | TRUE | 4 |
| 70 | TRUE | FALSE | 3.5 |
| 70 | FALSE | TRUE | 3.5 |
| 70 | FALSE | FALSE | 3.5 |

In some implementations, for savings, the algorithmic valuation function can be constructed as: [1+exp(−b/T−a)]/[1+exp(−b×(1−C/I)/T−a)], where T is the target months of reserves (from the above table), C is the total cash excluding earmarked cash, and I is the gross monthly income. The latter two variables are based on data inputs from the system. The coefficients a and b vary by a user's savings habit. Other mathematical representations are also possible.

The “degree of disparity” can be illustrated based on a case of a person having a gross monthly income of $5,000 and a target of 4 month of savings. The higher the “valuation” measure the greater the degree of disparity and the greater the exposure in insufficient savings. If a user has no savings deposits, a factor that is a proxy for a savings habit, then having as much as $15,000 in total cash is considered “far” from the target. On the other hand, if a user exhibits at least 2 savings deposits, the amount of total cash is considered “close” to the target. In some models, there may be no penalty for having excessive total cash beyond the target number of months.

In some examples, progress metrics for savings depend on the current value of the color code of a user's savings assessment (as discussed later). If the savings assessment is “g” or “y” then progress metric is set to 0.50. If the savings assessment is “o” or “a” then progress metric is set to 0.75. If the savings assessment is “r” then progress metric is set to 1.00.

Category weights for savings also depend on the current value of the color code of a user's savings assessment (as described later). If the savings assessment is “r” then category weight is set to 15. If the savings assessment is “a” then category weight is set to 12. If the savings assessment is “o” then category weight is set to 6. If the savings assessment is “y” or “g” then category weight is set to 3.

The overall score of a user's savings domain is computed as the product of category weights, progress metric and valuation output.

At the fourth stage, the assessment component generates relative assessment values 124 (e.g., scores or rankings), which can be numerical values representing relative states of the respective financial facets and relative potential upsides and risks associated with the respective facets based on the policies (e.g., fiduciary policies). The relative assessment values can be determined for each facet and can be weighted to produce a holistic assessment value for the entirety of the user's financial domain. The facet and holistic scores can be maintained internally or can be communicated to the user through a user interface of an app or application or browser running on a device. In addition, the per-facet and holistic assessment values can be used to trigger actions including allocation moves or actions 126 (e.g., using resources according to allocations), prioritization actions 128, and presentation actions 130 through a user interface to a user.

Implementations of the assessment model can include (1) numerical scoring functions that measure a user's current financial situation with respect to target policy; (2) weighting factors that place different emphases on the respective financial facets according to policy; (3) progress metrics that identify changes of a user's financial behaviors; (4) a mechanism to estimate any identified cash resources on both recurring and one-time bases; (5) a weighted scoring scheme that apportions any identified available cash resources among needs indicated by the state of the user's financial domain; (6) more granular segmentation; (7) expanding allocation of resources to other goal-based financial needs (e.g., accruals to infrequent and planned expenses); and (8) incorporation of expert opinions, user preferences, and predictions based on the behavior of similar users.

Therefore, the assessment model shown in FIGS. 3 is holistic and can comply with fiduciary standards because it can access all data sources and assess the values of state parameters to form actionable scores that can be used for allocation, prioritization, messaging, moves, and actions, which collectively aim at improving a user's financial state.

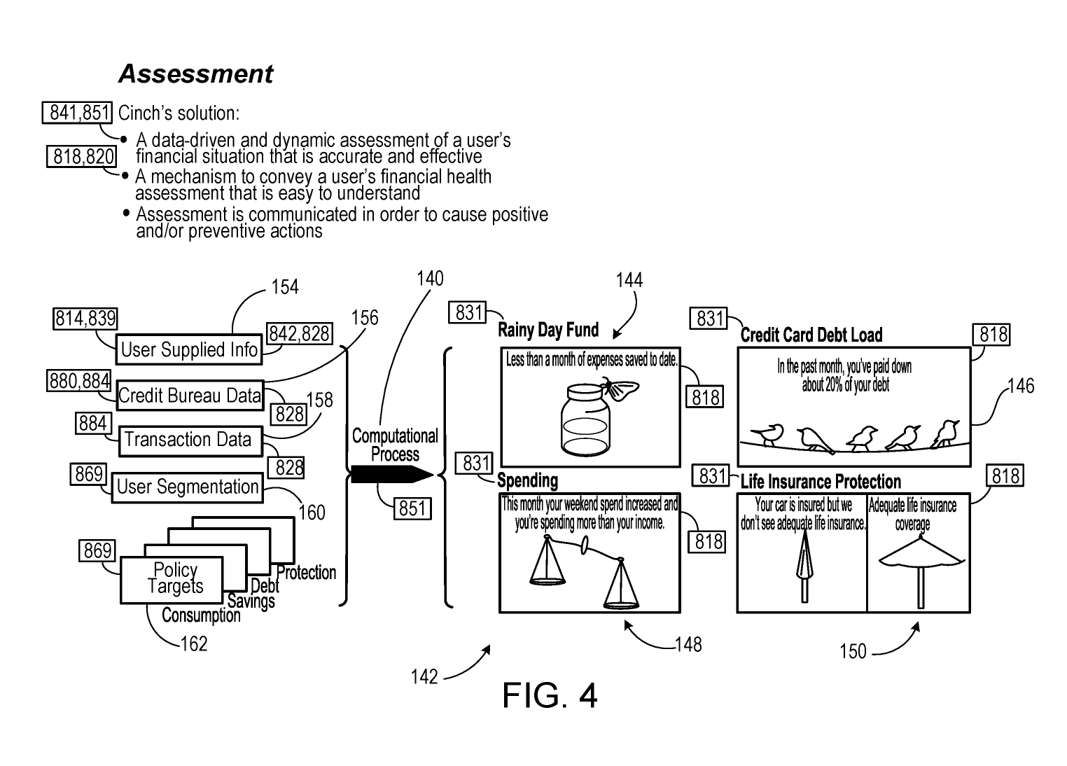

FIG. 4 shows additional aspects of the assessment process performed by the assessment component and illustrates how the results of assessment can be presented for easy visualization by a user.

As shown in FIG. 4, the computational processing 140 implied by FIG. 3 can result in scores for each of several facets of the financial state of a user's financial domain. Within each facet the score can be expressed as a relatively small number of discrete values in a range. The values in the range can be passed to a user interface of a mobile app, for example, that can present the values through visible metaphorical representations 142. FIG. 4 illustrates one of the metaphorical representations in the range for each of four facets, savings (amount of water in a jar) 144, credit (number of birds perched on a line) 146, spending (angle of a balance arm) 148, and life insurance (open-closed position of an umbrella) 150 of the consumer's financial domain. Additional information about metaphorical representations can be found in U.S. patent application Ser. No. 15/681,462, filed on Aug. 21, 2017, and incorporated here by reference in its entirety.

As illustrated in FIG. 4, the assessment process of the computational technology receives inputs representing values of state parameters of the consumer's financial domain (including, for example, user supplied information 154, credit bureau data 156, and transaction data 158), performs user segmentation 160, and takes account of policy targets 162 for the relevant facets of a financial domain (consumption, savings, debt, and protection, in this example), among other things, and produces evaluations (scores) for each of the facets.

Therefore, the assessment is data-driven and dynamic and produces assessments that are accurate and effective and are presented metaphorically to help the user to take steps to improve the evaluations and to provide to the user an indication of the current states of the relevant facets. The metaphors are easy to understand, serve as useful aspects of a user experience, and motivate the user to take action.

In the implementation of the assessment system, the policy targets serve as a frame of reference for measuring a state of a user's financial domain. An initial segmentation step captures the main dimensions (facets) of financial states and temporal stages of those states. A simple color code (described later) is applied to financial assistance that is provided for different facets, so that the user can easily recognize them.

Thus, the assessment stage (which we also sometimes call the assessment model) aims to provide a holistic fiduciary-grade view of a user's financial situation using available data from a range of sources. Among the outputs of the model are a holistic score (or a score for each facet or combinations of facets of the financial domain). The score(s) would be used to guide moves and actions such as allocation of funds, prioritization, and messaging to the user.

### Prioritization Stage

Based on the results of the assessment stage, the computational technology generates a list of possible moves each of which can benefit or otherwise alter the financial state of the consumer's financial domain. Moves can be directed to actions that may be taken automatically on behalf of or manually by a consumer with respect to corresponding financial facets. For example, moves could include steps in a plan to pay down debt, recommendations for financial products such as mortgages, or steps to work towards behavioral changes of the consumer (such as spending challenges aimed at reducing a consumer's spending).

The moves generated by the computational technology can be prioritized based on pre-specified criteria.

Consider an example in which there are a number of financial facets and moves to be ranked together. Each financial facet's rank is obtained by ordering the total scores calculated for all applicable facets in a descending manner. For example, if the scores are calculated as follows Consumption: 0.798. Savings: 2.878. Debt: 0.025. Protection: 0, then the highest ranked facet is Savings, followed by Consumption, Debt and Protection in this order.

There can be multiple moves within each facet. The ranking of moves is performed within each facet first, and then all moves across all facets are lined up by their respective facet ranks. The rankings may be changed as more moves are added to the platform. Also, the prioritization or ranking can be evaluated across facets, for example, 401(k) savings could be prioritized over debt repayment but not over other types of savings (e.g., brokerage or reserves).

For example, suppose a user has Consumption score of 0.798 which is ranked 2 as noted above. Within Consumption there are two applicable moves: Spending Challenge and Checking Fees with financial impacts expected to be $136 and $25, respectively. As a result, the Spending Challenge is ranked higher than Checking Fees. Putting the results together, the ranks for all moves are: Savings: 1, Spending Challenge: 2, Checking Fees: 3, Debt: 4.

The indicated moves attempt to generate more money first from managing spending and eliminating banking fees (in this case these generated monies are not expected to be one-time amounts, i.e., they are recurring). Protection is dropped since there is no need to communicate a move for Protection if it is not needed by the user.

The prioritization (ranking) need not be static but can be updated as assessments change. In some cases, the ranking of moves can be done simultaneously across two or more facets of the financial domain. Ranking can account for how much time it will take for a move or action to affect the state of a facet, how easy the move or action will be to perform, how much improvement in financial state a move or action will produce, and user preferences that affect which moves or actions are more acceptable (for example, a user may be happy to try to change spending habits but not interested in changing banking institutions).

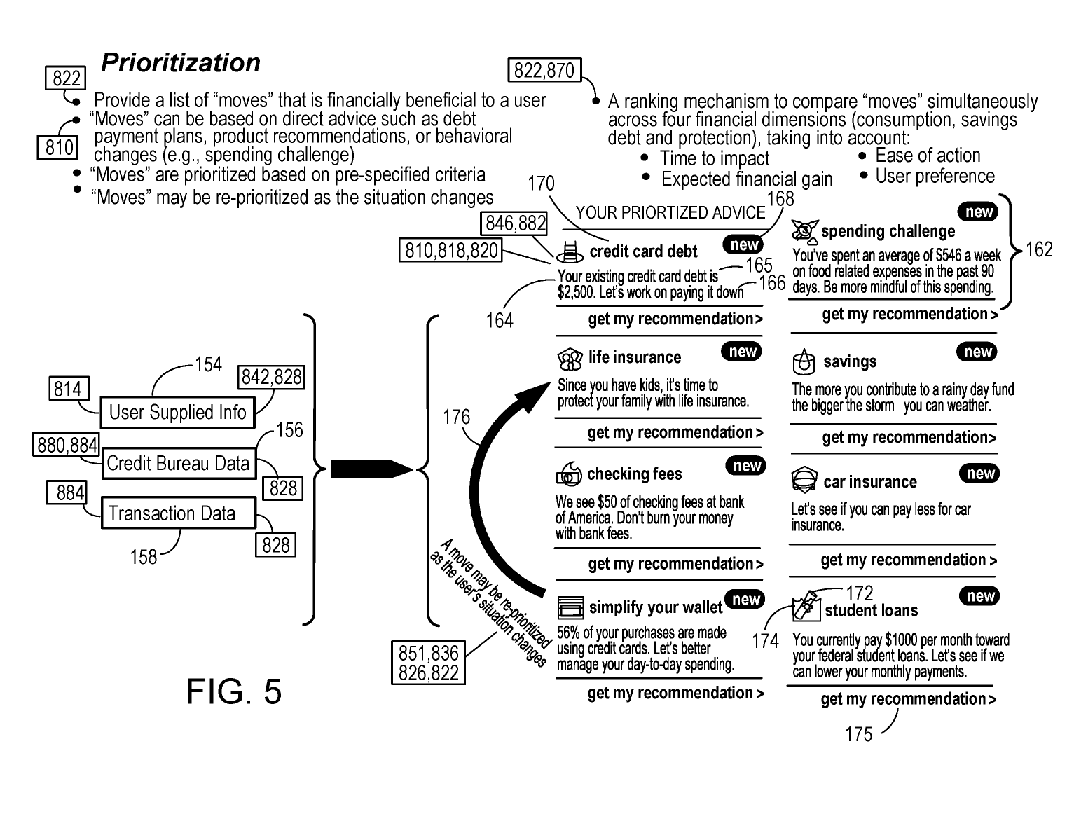

As shown in FIG. 5, through the user interface presented by the user's device, each of the moves or actions can be introduced using a panel or card 162. In this example, the cards are presented in a current order of priority of the moves from top to bottom in the left column and then down the right column. Each card includes a plain language easy-to-understand introductory statement 164 for a move or action. The statement includes an accurate reporting of a state of a facet of the user's financial domain such as an amount 165 of credit card debt based on credit bureau data or transaction date. The introductory statement also includes an encouragement message 166 that suggests that a move or action should be taken but without describing the details of the move or action. A flag 168 reports if this is a move or action that is being newly presented to the user. A headline 170 alerts the use of the general topic of the move or action. And overlaid icons 172 and 174 suggest the nature of the move graphically. The icon 172 symbolizes the subject, such as a diploma, to suggest the topic of the move or action relates to college. The icon 174 has a shape and color that indicates the nature of the move such as a shield to refer to insurance and the color blue to suggest water. Typically each card does not describe the actual details of the proposed move, but rather serves as a “teaser” and provides a link 175 called “get my recommendation” to take the user to the details of the move.

As the states of the user's financial domain or facets change, the computational technology may change the rankings of the moves or actions; in response the user interface changes 176 the positions of the cards in the prioritized arrangement.

For example, at an earlier time the rendered advices could be presented (in the form of the advice cards) in the order of Savings, Spending Challenge, Checking Fees and Debt. The order was determined by the total scores across the financial facets and moves applicable at that time.

Then, at a later time, the user's financial states may have changed. In particular, the user may have taken up the Spending Challenge and also opened a new savings account to deposit the suggested $300 savings amount. On the other hand, the user may not have dealt with the advice of paying checking fees and the credit debt balance may be maintained at the same level. As a result, the display of these cards at the later time follows a new order (together with the message accompanying each card).

In some implementations, the ranking mechanism compares moves simultaneously across multiple (e.g., four) financial facets (for example, consumption, savings, debt and protection), taking into account several factors. The factors could include, for example, the amount of time between the implementation of a move or action in the occurrence of an impact on the state of the financial domain; the financial gain or other improvement in the state of the financial domain that might be expected from the move or action; the ease of implementing the move or action; and user preferences.

### Allocation Stage

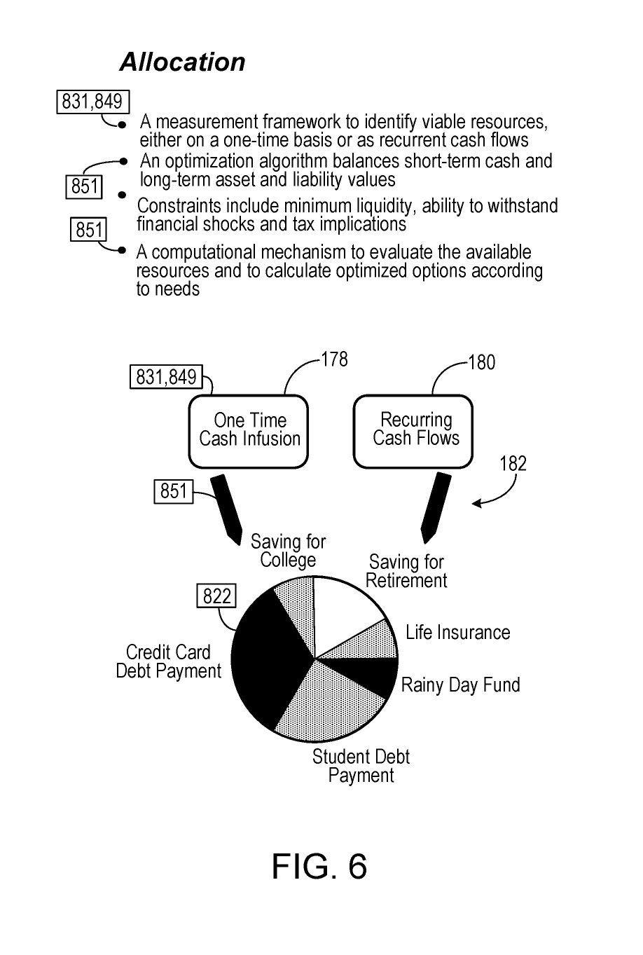

In addition to the assessment and prioritization stages, the computational technology can implement an allocation stage as shown in FIG. 6. In the allocation stage, the computational technology applies a measurement framework to identify viable available resources. In this example, involving a financial domain of a consumer, a typical resource is cash that is available either as a one-time infusion 178 or from recurring flows 180. Allocation involves applying the computational technology to decide on a desirable division of the cash resource among a set of possible moves or actions 182. In some implementations, the computational technology applies an optimization process to balance short-term cash and long-term assets and liabilities while determining allocations to possible moves or actions under constraints such as a minimum liquidity, tax implications, and withstanding financial shocks.

The following example illustrates the tradeoff between short-term cash and long-term assets and liabilities. Suppose a user has financial situation as follows: gross monthly income=$8,333, credit card revolving balance=$2,300, credit card minimum payment=$58, total cash excluding earmarked cash=$7,272, number of savings deposits=3, number of children=0, homeowner=FALSE, age=36.

Based on an existing policy and data above, the total scores for this user could be 2.878 and 0.025, for the savings and debt facets, respectively. In this case, the need of building greater cash buffer outweighs the current level of debt payment. As a result, a larger amount of available money will be allocated to savings. The savings move (or action) will direct the user to put more into a savings account. The strategy to realize this move (not shown here) will take into account any minimum level of liquidity or cash flow need to be maintained. Assuming no new addition to debt, the savings will grow while the debt balance will shrink (although more slowly) over time. At some point, the tradeoff between savings and debt will cross over, resulting in more money being allocated to debt payment, ceteris paribus.

### Moves and Actions

FIG. 7 shows an example of how potential moves or actions can be analyzed.

The upper half of the left column 280 of FIG. 7 identifies state parameters 282 (called model values in the figure) that can be considered in characterizing the state of a real-world domain, in this case the financial domain is associated with a particular person.

Each of the state parameters bears an identifier that is part of an ontology used internally by the computational technology. For example, the third state parameter 284 is identified as user.monthly_cash_expenses, which is an entry in an ontology that relates to financial management.

The remaining columns to the right illustrate values of the parameters at successive times beginning with day X and ending with day X+45. For example, the user's monthly cash expenses as of day X were determined to be $7009.21. This information was accumulated from banking and credit card statements and other ingested data that was converted to values corresponding to the ontology. As of day X+15, the monthly cash expenses had grown to $7573.12. And, as of day X+45, the monthly cash expenses had declined again, to $7488.63. Each of the values of each of the state parameters in the chart is similarly derived from relevant ingested data that has been converted according to the ontology. Although only data for certain spaced-apart days are shown in the chart, of course, the dynamic determination or assessment of each of the values could be done every day, or several times a day, or many times a day, or periodically, or on demand.

The bottom half of FIG. 7 contains rows representing possible moves that could be made to improve the state of the person's financial domain. These rows illustrate how the moves can be prioritized at each time according to the user's changing financial state. Although numerical values and timing shown in this example are hypothetical, the ranks, scores, and moves prioritization are actual results generated by the computational algorithm of the computational technology.

There are five facets of the person's financial domain that are shown as being ranked (scored) at each of the given times: spending, checking, reserves (savings), debt, and life insurance.

1. On Day X, the user had only three moves, namely, the three moves that bear the rankings 2, 3, and 1. Those rankings indicate the relative priorities of the three modes, with 1 having the highest priority. The other two moves (with respect to debt and life insurance) were given the ranking (e.g., scored) as 999 indicating that they should not be considered as of that day. The reasoning of the computational platform was as follows:

a. The assessment component determined that the person's existing cash position was low. The presentation component presented information to the user that advised the user to increase savings to achieve a higher level of liquidity for emergency purposes. The weighted score for the reserves facet was 2.878—the highest among the five financial facets. Hence, “move reserves rank” was 1 indicating that the best move was to save more money.

The determination that the cash position was low could be made as follows in this example: The existing cash position was TotalCashExEarmark=$7,272 from data input, which was lower than the monthly gross income MonthlyGrossIncome=$8,333 from data input.

The weighted score for the reserves could be determined as follows. 2.878=Prioritization Weight×Financial Score×Progress Score=6×0.6396×0.75. Prioritization Weight=6 based on the policy that this user's savings assessment was “o”. Savings assessment=“o” because target research level had not been reached, and total cash excluding earmarked cash was less than gross monthly income but there are enough number of savings transfers.

Financial Score=0.6396=[1+exp(−6/TargetMonthsOfReserves)]/[1+exp(−6/TargetMonthsOfReserves×(1−TotalCashExEarmark/MonthlyGrossIncome))]=[1+exp(−6/3)]/[1+exp(−6/3×(1−7272/8333))],

where TargetMonthsOfReserves=3 based on savings target that this user was age 36 and not a homeowner, and had no dependents; TotalCashExEarmark=$7,272 from data input; MonthlyGrossIncome=$8,333 from data input; and Progress Score=0.75 based on the policy that this user's assessment was “0”.

b. The assessment component determined that the user's spending was in check. The state parameter called “monthly cash expenses” was lower than the state parameter called monthly net income, and $0 of credit card balance was not in revolving status. However, the level of spending was close to income. The presentation component provided information to the user to advise the user to take up a challenge for mindful spending. The weighted score for the consumption facet was 1.763, and the estimate of financial impact of the consumption facet was $140. Therefore the scoring component set the rank of the spending challenge move at 2.

The weighted score for the consumption facet—1.763—was as follows. 1.763=Prioritization Weight×Financial Score×Progress Score=6×0.2939×1.0. The Prioritization Weight=6 based on the policy that this user's consumption assessment was “o”. The consumption assessment=“o” because data input ConsumptionFlow stayed within the target of range of consumption flow to income ratio (10%). The Financial Score=0.2939=1/[1+exp(5×ConsumptionFlow/TotalMoneyIn/TargetCFtoIncome)]=1/[1+exp(5×125/7134/0.1)] where ConsumptionFlow=$125 from data input, TotalMoneyIn=$7,134 from data input, TargetCFtoIncome=0.1 based on savings target that this user was age 36 and not a homeowner, and had no dependent, and Progress Score=1.0 was a scalar set at a constant value (for the current model version).

The estimate of financial impact of the consumption facet was calculated as follows. 140=(TotalCashSpend+TotalCreditSpend)×ImpactPercentage=(7009+0)×2%, where TotalCashSpend=$7,009 from data input, TotalCreditSpend=$0 from data input, and ImpactPercentage=2% was a scalar set at a constant value for the current model version which was subject to change based on policy.

c. The assessment component determined that the user was charged a monthly checking fee of $25. The presentation component provided information to the user to advise the user to circumvent the fee paid to the bank on this checking account. For example, the user could be encouraged to open a new free checking account at another banking institution identified by the computational technology, for example, a banking institution included in an inventory of banking institutions and their products. The weighted score for the consumption facet was 1.763, and the estimate of financial impact the checking account monthly fee was $25. Therefore, the ranking of the move to change checking accounts, “move_checking_rank”, was 3.

In this example, the ranking (scoring) was based on the relative dollar impact of respective moves on the state of the user's financial domain. The greater the dollar impact, the higher the ranking, and the higher the ranking, the worse the state of the user's financial domain or the greater the user's risk exposure or both. In some implementations, the ranking (scoring) may incorporate additional non-monetary criteria such as ease of execution or a user's preference.

Therefore, as of day X, the computational technology would advise the user first to increase reserves, second to accept a spending challenge and third to switch checking accounts. In some implementations, the presentation component could ask the user for approval for one or more of the moves. If approval is given through a user interface, the action components could then effect the moves or assist the user in effecting one or more of the moves.

2. On day X+15, the assessment component determined that the user had the same three moves and that the three moves were ranked differently. The reasons were:

a. Monthly cash expenses increased by over $500 and exceeded monthly net income for the month. The user was advised to address the issue of spending. The weighted score for the consumption facet increased to 5.735—the highest among the four facets, and the estimate of financial impact increased to $151. Hence, “move_spending_challenge_rank” was 1.

b. To address the identified spending issue, the assessment component scored the checking move as 2, and the presentation component provided information to the user advising elimination of the existing checking fee with an estimated financial impact of $25.

c. Based on a determination by the assessment component, the consumption facet displaced the savings facet in the rankings, with a weighted score of 2.980. The reserves move was therefore ranked at 3.

3. On Day X+26, the user had four ranked moves including the spending challenge, switching of the checking account, increasing of savings reserves, and reducing debt. The reasons were:

a. The assessment component observed a revolving credit card ending balance of $2,300. The user's credit card APR was calculated by the assessment component to be 18%, resulting in a required minimum payment of $58. All things considered, the debt load was deemed manageable. With weighted score for the debt facet at 0.025—the lowest, the assessment component ranked the debt move at 4. The presentation component provided information to the user to advise the user to prioritize paying down the outstanding balance of the credit card (in other words reduce the debt).

In this example, the weighted score was calculated as follows. 0.025=Prioritization Weight×Financial Score×Progress Score=4×0.0062×1.0. Prioritization Weight=4 based on the policy that this user's consumption assessment was “g”. Consumption assessment=“g” because data input LikelyTransactor was set to TRUE. (In this example, all previous credit card balances had been zero.) Financial Score=0.0062=1/[1+exp(6.6−11×CreditCardMinPayment/MonthlyGrossIncome/TargetCCPaymentObligation)]=1/[1+exp(6.6−11×58/8333/5%)], where CreditCardMinPayment=$58 from data input, MonthlyGrossIncome=$8,333 from data input, TargetCCPaymentObligation=5% based on debt target that this user was age 36 and not a homeowner, and had no dependent, Progress Score=max[1.0, PaymentSpeed/(CreditCardAPR/12+1%)=max[1.0, 0%/(18%/12+1%)]=1.0, where PaymentSpeed=0% CreditCardAPR=18% from data input, and PaymentSpeed=(CreditCardPayment−TotalCreditSpend)/[3×(CreditCardPayment−TotalCreditSpend)+CreditCardBalanceRevolving×(1−CreditCardAPR×3/12)]=(0−0)/[3×(0−0)+2300×(1−0.018×3/12)], where CreditCardPayment=$0 from data input, TotalCreditSpend=$0 from data input, and CreditCardBalanceRevolving=$2,300 from data input.

b. The scores for the other facets were determined by the assessment component to have remained about the same as for the previous calculation (consumption facet, 5.817; savings facet, 2.969) and their rankings as moves stayed the same.

4. On Day X+31, the user had three ranked moves. The reasons were:

a. The assessment component observed no more checking account fees. The user changed the checking account to a different banking institution entirely. As a result, the checking move was not ranked (999). Because the user switched, the system would know with certainty one of the outcomes referenced.

b. All other facet ranks remained the same, and the corresponding moves took on the same relative ordering as before, adjusted for the total number of moves. For example, “move_spending_challenge_rank” stayed as 1.

5. On Day X+44, the user had three moves but they were ranked differently. The reasons were:

a. The assessment component observed an infusion of cash of over $10,000 (possible reasons might include a deposit of an annual bonus or a lump sum tax refund). The higher liquid fund level cause the assessment component to determine a reduced score for the savings facet of 0.277 and set the rank of the reserves moved to 3.

b. The assessment component determined that spending remained elevated above net income, leaving the determined weighted score for the consumption facet at 5.337. The “move_spending_challenge_rank” stayed as 1.

c. The assessment component determined that, meanwhile, the credit card revolving ending balance had increased by more than $5,000. The heavier credit card debt load increased the required minimum payment to $185, and the weighted score for the debt facet increased to 0.610. On a relative basis, this left the “move_debt_rank” at 2.

6. On Day X+45, the user had four ranked moves. The reasons were:

a. Information provided by the user to the computational technology, and used by the assessment component, indicated that the number of children had increased from 0 to 1. Based on the stored rule that a purchase of a life insurance policy (life insurance move) having sufficient coverage should be recommended if a user has at least one child and there was any existing gap in coverage. The assessment component determined that the gap for this user $1,000,000 (not shown) and determined that the weighted score for the protection facet had become 1.000 (previously 0.000). On a relative basis, this set the rank of the life insurance move at 2.

b. The ranks for all other facet scores remained the same, and the corresponding moves were assigned the same ordering as before, only to be adjusted for the new total number of moves. For example, “move_spending_challenge_rank” remained as 1 but “move_debt_rank” now was 3 and “move_reserves_rank” 4.

### User Interface Visual Devices

In addition to the metaphorical user interface elements described above, implementations of the assessment, prioritization, and allocation stages can also provide a variety of other useful user interface features that aid the user in understanding the financial assistance being given.

For example, a color scheme could be defined for the user interface presentation with respect to each facet of the financial domain. Color schemes tend to be easy for users to recognize and understand and are therefore useful in connection with the presentation of information on a user interface. In some implementations, a five-color scheme can be used for a credit card debt facet with different colors indicating percentages of gross income needed to service the required minimum payment. For example, there could be five different percentages represented by five colors. A five-color scheme could also be used for the consumption facet based on consumption flow as a percentage of gross income above (or below) policy targets. The flows could also be based on the current liquidity condition. A five-color scheme for the savings facet could be based on the level of liquid cash as a multiple of gross income, and also on any existing savings. A four-color scheme for the protection facet could be based on life insurance coverage gap and family status.

In some examples, the five colors for credit card debt could be:

Green: if a user is deemed a credit card transactor, then the color code for debt is assigned “g”.

Yellow: if the ratio between total minimum credit card payment and monthly gross income is less than the target policy for a user's credit card payment obligation and if the user's credit card balance trend is flat or decreasing, then the color code for debt is assigned “y”.

Orange: if the ratio between total minimum credit card payment and monthly gross income is less than the target policy for a user's credit card payment obligation and if the user's credit card balance trend is increasing, then the color code for debt is assigned “o”.

Amber: if the ratio between total minimum credit card payment and monthly gross income is greater than or equal to the target policy for a user's credit card payment obligation and if the user's credit card balance trend is flat or decreasing, then the color code for debt is assigned “a”.

Red: if the ratio between total minimum credit card payment and monthly gross income is greater than or equal to the target policy for a user's credit card payment obligation and if the user's credit card balance trend is increasing, then the color code for debt is assigned “r”.

The five colors for consumption could be as follows:

Green: if a user's consumption flow divided by a user's gross monthly income is greater than the target consumption-flow-to-income ratio, and if a user is either a credit card transactor or a user's 12-month credit balance trend is non-increasing, then the color code for consumption is assigned “g”.

Yellow: if a user's consumption flow divided by a user's gross monthly income is greater than the target consumption-flow-to-income ratio, and if a user is both a credit card revolver and a user's 12-month credit balance trend is increasing, then the color code for consumption is assigned “y”.

Orange: if a user's consumption flow divided by a user's gross monthly income is between the negative value of target consumption-flow-to-income ratio and the positive value of target consumption-flow-to-income ratio (i.e., the absolute value of the ratio of is less than the target value), then the color code for consumption is assigned “o”.

Amber: if a user's consumption flow divided by a user's gross monthly income is less than the negative value of target consumption-flow-to-income ratio, and if a user is either a credit card transactor or a user's 12-month credit balance trend is non-increasing, then the color code for consumption is assigned “a”.

Red: if a user's consumption flow divided by a user's gross monthly income is less than the negative value of target consumption-flow-to-income ratio, and if a user is both a credit card revolver and a user's 12-month credit balance trend is increasing, then the color code for consumption is assigned “r”.

The five colors for savings (liquidity condition) could be as follows:

Green: if a user's total cash excluding earmarked cash is at least three months of gross monthly income, or at least the number of target months of gross monthly income, then the color code for savings is assigned “g”.

Yellow: if a user's total cash excluding earmarked cash is at least one month but no more than three months of the user's gross monthly income, then the color code for savings is assigned

Orange: if a user's total cash excluding earmarked cash is no more than one month of the user's gross monthly income, and if the user has at least three savings deposits (on average), then the color code for savings is assigned “o”.

Amber: if a user's total cash excluding earmarked cash is no more than one month of the user's gross monthly income, and if the user has less than three savings deposits (on average), then the color code for savings is assigned “a”.

Red: if a user's total cash excluding earmarked cash is no more than one month of the user's gross monthly income, and if the user has no observable savings deposit, then the color code for savings is assigned “r”.

Red: if a user has no savings account or if a user has no gross monthly income, then the color code for savings is assigned “r”.

The four colors for protection could be:

Green: if a user has at least one dependent and the life insurance coverage ratio is at least 85%, then the color code for protection is assigned “g”.

Yellow: if a user has no dependents (zero), then the color code for protection is assigned

Orange: if a user has at least one dependent and the life insurance coverage ratio is at least 70% but not greater than 85%, then the color code for protection is assigned “o”.

Red: if a user has at least one dependent and the life insurance coverage ratio is not greater than 70%, then the color code for protection is assigned “r”.

The Life insurance coverage ratio is calculated as the ratio between ExistingLifeCoverage and the sum of ExistingLifeCoverage and LifeCoverageGap.

In general, a user interface for the computational technology that we are describing here can be designed to provide a stimulating user experience as a front-end. The user interface can communicate the state of the financial domain and recommendations, and can be crafted to motivate the user to take actions. For example, in some implementations, a dashboard can be provided to summarize the assessment of the user's financial domain and facets. In some cases, the user interface can provide a back story to explain the current state of a financial domain. The user interface could list prioritized moves or actions and financial assistance that are beneficial to the user. Step-by-step action plans could be presented on how to implement the recommended moves. User indicated responses and/or intentions (as well as their history) expressed through the user interface could be used to enhance future financial assistance. The system can provide email notifications about the state of the user's financial domain and changes in the state.

### Request for Allocation

In some implementations, assessments, allocations, moves, and executions are triggered by requests. The requests may occur as a result of user interaction with the user interface, such as when a user indicates a wish to spend money at a coffee shop or invest money in a retirement plan. Requests may occur automatically as a result of activities occurring in the computational technology or received from outside sources. For example, a manager of an investment account may send a request to the computational technology for a possible allocation of resources (e.g., an investment) in the investment account. In some cases, requests for allocations can occur internally within the computational technology in order to present possible allocations to a user. A wide variety of other circumstances can lead to internal or external request, either automatically or by action of the user.

### Fiduciary Principles

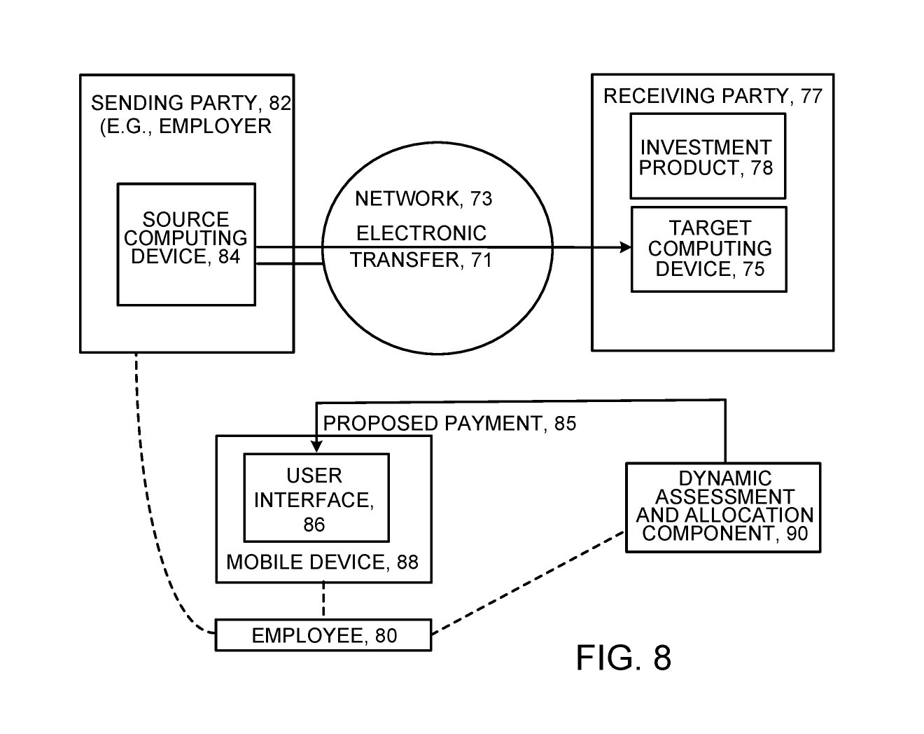

In some implementations, the computational technology (for example the dynamic assessment and allocation component 90 described with respect to FIG. 8 below) is hosted by a host party that operates the technology in a manner that complies with fiduciary principles. In such an operation, the assessment and allocation algorithms are designed to work solely for the benefit of the person whose financial domain is being assessed and whose resources are being allocated. In addition, the assessment and allocation algorithms operate without a bias or point of view that is separate from or inimical to the interests of the person being served. Examples of systems hosted in a manner that complies with fiduciary principles are described in U.S. patent application Ser. No. 15/844,034 filed Dec. 15, 2017, and incorporated here in its entirety by reference.

### 401(k) Plan Dynamic Allocation

Some examples of applications of the computational technology can achieve dynamic payments (allocations of resources) to investment accounts (uses of resources) such as 401(k) plan accounts.

Typically, the amounts of monthly payments for a given participant to a 401(k) plan are determined, say, annually in advance and are set at fixed identical monthly amounts for a coming year. The participant in the 401(k) plan may specify the monthly amount. In some cases, the fixed monthly amount may be changed at a given point during the year and then applies for all future monthly payments for that year. Commonly the participant sets the monthly payment amount at a level that will be financially comfortable (e.g., leave a cushion) for all months of the year.

It is not unusual for participants in a 401(k) plan to decide not to make any monthly payments at all because of concerns that they will not be able to afford those payments over the course of the year or for particular future months. Each of the payments actually made as of a given month may not appropriately reflect a state of the participant's financial domain, that is, may not reflect the resources of the participant then available. In a particular month, the person may comfortably be able to invest a larger amount in the 401(k) plan than the fixed monthly amount specified at the beginning of the year. Conversely, in a particular month, a planned fixed payment may be more than the person can comfortably afford. Requiring fixed monthly payments can result in the person investing less than her financial state would justify which can be a disadvantage.

As shown in FIG. 8, in some implementations, these concerns can be reduced or avoided by the computational technology by dynamically determining an amount of a payment to be made from an available resource involved in an allocation or move or action. The dynamically determined payment amount can be made by an electronic funds transfer 71 on a communication network 73 to a target computing device 75 which may be controlled or hosted by a receiving party 77. The receiving party can be a manager of an investment product 78. In some instances, the investment product may be a 401(k) plan and the receiving party may be acting as an agent to invest the payment in an account of the plan and manage the account on behalf of an employee 80 of an employer 82. The electronic transfer may be made from a computing device 84 hosted by the employer.

The employee may approve the payment when the proposed payment 85 is presented to the user (e.g., a plan participant) through a native app or a browser-served user interface 86 on a device such as a mobile device 88. Information about the proposed payment can be provided to the user from the sending party or the receiving party or both. In some implementations, the information about the proposed payment can be provided from a dynamic assessment and allocation component 90 which can operate as a trusted online fiduciary advisor to the employee. The dynamic component 90 may be executed on a computational device hosted by a third party that is independent and can implement fiduciary principles in the operation of the component. The assessment and allocation by component 90 can be done holistically to reflect an overall state of the financial domain of the employee, including a full set of facets of the financial domain. In other words, the computational technology can operate as a trusted fiduciary to determine and implement the amount of each monthly payment from an available cash resource of an employee to a 401(k) plan based on its current understanding of the overall state of the employee's financial domain. The determination can be accurate and current and can be made dynamically at a time related to the time when the payment is to be made. The determination may be made in response to a request from a user, from the computational technology, or from an external source. Examples of technology that can be used to implement such an arrangement are described in U.S. patent application Ser. No. 15/231,266, filed Aug. 8, 2016, and incorporated here by reference in its entirety.

The dynamic determination of an amount of an allocation or move or action (we sometimes use the word “allocation” to refer to any of the three) to be taken based on a state of a person's financial domain can be applied in determining such an amount in any of a wide variety of contexts including any of the following: each amount for a periodic series of amounts; an amount of an individual one-time allocation; an allocation to any kind of investment account or any other account that is a repository for a resource of the person; or a one-time, periodic, repeated, or occasional amount allocated to any purpose including consumption of any kind of financial or other product or service.

For example, in the consumption context, when a person wants to buy a car, the amount to be paid for the car could vary widely depending on the choice of the car to be bought. By assessing the state of the user's financial domain at the time of the purchase, the computational technology can advise the person how much money could reasonably be spent for the car and in that way enable the person to make a sensible selection.

In addition, the timing of the determination of the amount of the allocation can vary relative to the timing of the execution of the allocation. The determination can be made essentially at the same time or immediately before the allocation or at a predetermined amount of time before the allocation. The determination can be made in advance for a set of future allocations. Determinations of the amounts of one or more proposed allocations can be made essentially continuously, and can be reported to the person or to another party and used by other components of the computational technology for a variety of purposes, before (and whether) the proposed allocations are eventually executed.

The determinations of the amounts of allocations can be based on the states of individual facets, or combinations of two or more facets, or on a holistic set of the facets of the person's financial domain.

Basing the amounts of allocations on dynamic assessments of states of a person's financial domain yields benefits, particularly when the assessments and allocations are proposed or implemented (or corresponding financial assistance is given) by a computational technology that operates according to fiduciary principles on behalf of the person. For example, the person can trust the assistance or assessment or allocation to appropriately represent the state of her financial domain and therefore will represent investments or other expenditures that are well timed and in appropriate amounts. Parties that are the sources of resources or the hosts of programs that manage the use of resources for the benefit of the person (such as employers) can also be comfortable that the timing and amounts are appropriate and will take maximum advantage of those resources and programs. Recipients of allocations may receive larger amounts or more frequent amounts and yet be satisfied that the allocations are not over-burdening the person. In general these applications of the computational technology can facilitate the flow of resources in an economy in ways that are exactly suited to the states of people's financial domains rather than over-allocating or under-allocating resources as would otherwise be the case.

### Technology Implementation

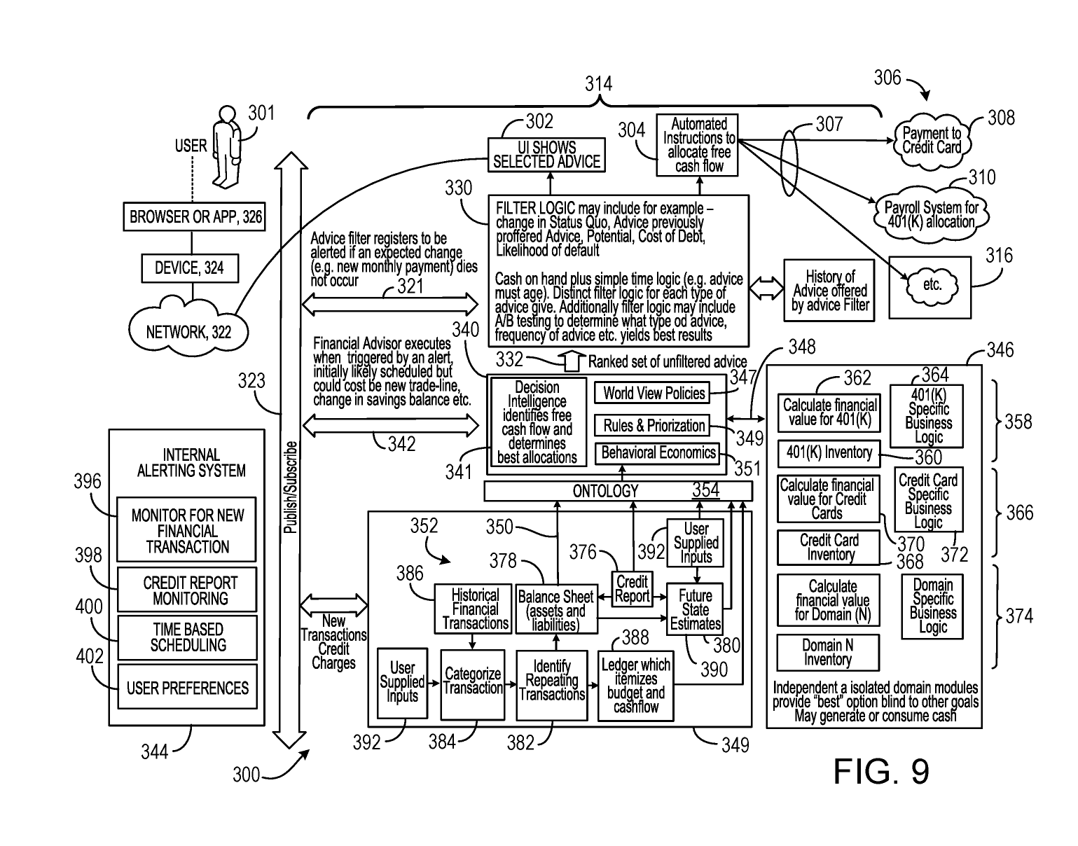

In some implementations, as shown in FIG. 9, in the context of a person's financial domain, the output of the computational technology 300 can be financial assistance 302 presented through a user interface of, say, a mobile device or can be automated instructions 304 to be executed to cause an allocation of financial resources (say, free cash) to one or more allocation targets 306. The resource allocation targets and the moves or actions 307 to execute the instructions (which we sometimes call “allocation transactions”) could include, for example, a payment 308 to reduce a balance on a credit card made through a payment processing computer of a bank or a directive to a computerized payroll system 310 of an employer to invest a specified amount in a 401(k) plan of an employee, or others 316.

In each case of an automated execution of an allocation transaction, the computational technology executed on the host computer system 314 supplements, cooperates with, and communicates automatically with an allocation target computer system. The interaction between the computer systems with respect to a particular allocation transaction can include passing of data (such as a user account information, the amount and timing, confirmation of receipt of the data, and confirmation of the effectuation of the allocation transaction) and commands (such as a directive to effect the transaction in the identified account). The execution of the allocation transaction can occur completely automatically without participation by the consumer 301 and, in some cases, without the knowledge of the consumer. In some implementations, information can be presented to the user that reports the terms and timing of the proposed allocation transaction and confirms the completion of the transaction.

In the example of a person's financial domain, the financial assistance 302 to be presented by the computational technology through the user interface to the consumer can range from direct to subtle. The direct financial assistance may, for example, present the consumer with the plan of the computational technology to allocate $2,444 to the user's 401(k) plan in June unless the user countermands or fails to approve that plan. The subtle financial assistance may, in some cases, be simply to present the user a table showing the payments to the 401(k) plan in the past twelve months. In various cases, the financial assistance can include simple information, metaphorical indications of financial state, educational lessons about finance, guidance, persuasion, feedback, requests for instructions about possible allocation transactions, identification of proposed allocation transactions, proposed allocation transactions that will be effected if not countermanded, and allocation transactions that have been effected, among other things. Financial assistance can be one-directional, from the computational technology through the user interface, or bi-directional involving replies, information, or confirmations interactively provided by the consumer through the user interface.

The one-directional or bi-directional interaction can occur between a computer system 314 of the computational technology through a network 322 with a mobile or other device 324 of the consumer which is running a Web browser or a native application 326 configured to present financial assistance to the consumer and receive information and commands from the user.

In some cases, described above, the financial assistance can be in the form of metaphorical graphical elements that represent aspects of financial assistance or can incorporate other visual elements and techniques to make it easier for the person to understand and act on.

### Financial Assistance Filter Component

The computational technology includes a financial assistance filter component 330 that selects allocation transactions to be effected automatically, financial assistance about allocation transactions to be presented to the consumer, or both. As noted earlier, in some cases, the financial assistance can be related to automatically effected allocation transactions.

The financial assistance filter component can be software running on a computer system of the computational technology and can be organized as modules. The software can receive as one input a ranked set 332 of resource allocation tactics. Each resource allocation tactic can comprise an element of financial assistance about a resource allocation for consideration or approval by a user, an instruction (with relevant details, such as amount, account, date) to execute an allocation transaction, or a combination of them. In some cases, the item can include a script that defines how to conduct an interaction with the consumer about an allocation transaction. For example, the script could provide text to be presented to the consumer (“May we invest $2,399 in your 401(k) account in June?”) and could determine whether to effect the allocation transaction based on the consumer's reply (Yes or No). In some cases the item can include a script that defines how to execute an allocation transaction, such as the network address of the target computing system, and relevant account information.

A wide variety of considerations can be taken into account by the computational logic that implements the financial assistance filter in selecting resource allocation tactics from the ranked set that it receives. The details of the filtering logic applied by the financial assistance filter can vary depending on the type of resource allocation tactic involved.

In the selection of resource allocation tactics, their simple ranking in the input set is a key consideration. As a resource allocation tactic ages (based on a time-stamp associated with the financial assistance that it represents) it may become less appropriate to implement, and the extent to which aging reduces the relevance of such an item will depend on its nature and timing. For example, financial assistance to buy life insurance on the birth of a child may age very slowly, while financial assistance to spend less for breakfast at Joe's Hash House can age very rapidly. An allocation transaction that involves investing more money in a 401(k) plan can age rapidly as April 15 (tax day) approaches, and can become irrelevant after that.

Selection of resource allocation tactics from the set can be based on an amount of available resources (e.g., cash). When available cash increases, resource allocation tactics aimed at constraining spending can become less relevant, and vice versa.

The computational logic of the financial assistance filter can also be configured to conduct experiments to determine which kinds of resource allocation tactics are most effective in altering the state of the financial domain (or its facets) of a person. By selecting alternative resource allocation tactics (A and B) and tracking the resulting states of the financial domain the financial assistance filter can infer which item (A or B) is more effective and can apply that inference in future selections. For example, A may be financial assistance in the form of a gentle suggestion to spend less money on computers at BestBuy and B may be a more aggressive insistence on specific approval by the consumer before the computational technology will allow the additional spending on the consumer's credit card.

Among other factors considered by the computational logic of the financial assistance filter may be a recent change in the state of the financial domain of the consumer, the relationship of a resource allocation tactic to a previously selected resource allocation tactic (if an investment in a 401(k) was already made automatically for June, do not suggest to the consumer that he make such an investment), a potential cost associated with a resource allocation tactic (incurring more debt implies incurring additional future debt costs), and the likelihood of an adverse occurrence associated with an item (defaulting on debt has future consequences).

The financial assistance filter component maintains in storage and uses historical information about the resource allocation tactics previously implemented.

### Resource Allocation Tactic Generator Component

In the computational technology that we are describing, a resource allocation tactic generator 340 applies computational logic 341 to generate potential resource allocation tactics for consideration and to rank them as a set for delivery as an output to the financial assistance filter. The computational logic of the item generator can be executed (e.g., frequently) on a regular schedule or at particular scheduled times or can be triggered 342 by the occurrence of changes in underlying financial information that imply a need for re-execution. One source for such triggers is an internal alerting system 344 described later.

Inputs to the computational logic of the item generator include facet modules 346 (described later) that include computational logic. Each facet module is operated independently and in some cases in isolation to provide potential allocation tactics 348 that are considered good or best by a goal defined internally to that module and in some cases without regard (blind) to other goals.

Other inputs are provided by a financial data ingestion component 349 that provides financial data elements 350 (e.g., values of state parameters) from a range of data source modules 352. The data elements 350 can represent historical, current, or predicted future values of financial state parameters or user supplied inputs 392 (including preferences). The input financial data elements are processed by an ontology component 354 to map or convert them into data elements that conform to an ontological structure that is understood and easily used by the item generator. Examples of the use of such an ontology component and ontological structure are described in U.S. patent application Ser. No. 15/593,870, filed on May 12, 2017, incorporated here by reference.

Inputs to the computational logic 341 of the item generator also include elements that guide the generation of resource allocation tactics. These elements are generated or stored by computational logic modules. A world view policy module 347 stores or generates policies based on an understanding of aspects of the world that impact the state of the financial domain of a person. For example, the policy may set a 6% annual 401(k) contribution target for retirement based on the consumers age, income, location, employer match, and plan type. If achieved this would optimize the savings financial domain of the person. In combination with a target for overall DTI ceiling such as 15% and other metrics would in combination represent the person's optimized financial domain. A rules and prioritization module 349 stores or generates rules that apply to the generation of resource allocation tactics and to determining how to prioritize respective resource allocation tactics. For example, the rules prioritization module would evaluate the person's current financial state with regard to the optimal annual retirement contribution, the optimal overall DTI, the impact on each from incremental resource allocation, and the relative near and long term risks posed by inaction (e.g. if the current 401(k) contribution is 5% vs. the 6% target and the expected return from a marginal dollar contributed is 5% [no match remaining] and the DTI is 25% vs. the 15% target and the expected return from a marginal dollar contributed is 15% the allocation would favor a marginal dollar to debt). A behavior economics module 351 stores and generates principles that express how financial behaviors of a person will affect the state of the person's financial domain.

Among other things, the computational logic 341 provides decision intelligence that identifies available resources (e.g., cash) and determines and ranks resource allocation tactics that represent a potentially good or best allocation of resources of the person.

### Facet Modules

The facet modules 346 include a range of software elements configured to provide information and analysis of external factors that may be used in generator resource allocation tactics.

A suite of modules 358 operates with respect to the financial facet of 401(k) plans. A 401(k) inventory module 360 acquires, stores, and provides information about 401(k) plans and plan options available to employees of entities. A 401(k) calculation module 362 computes a monetary value (positive, zero, or negative) of each 401(k) plan or option, for example, the expected return including the employer match and the risk adjusted investment return. A 401(k) specific business logic module 364 computes the future state (retirement) funding target, required contribution amounts and tax considerations, for example, how much the person should allocate between 401(k), Roth IRA or traditional IRA options based on income, employer match amount, expected return, investment allocation and distribution flexibility.

A second suite of modules 366 operates with respect to the financial facet of credit card products. A credit card inventory module 368 acquires, stores, and provides information about available credit card accounts and credit card options. A credit card calculation module 370 computes a monetary value (positive, zero, or negative) for each credit card product or option. For example, a credit card may have a negative monetary value of $X if its annual percentage rate is higher than some average percentage Y %. A credit card specific logic module 372 computes whether the current card is the most favorable option given the consumer's risk criteria and determines expected benefit or refinancing. For example, the logic module may determine the consumer can with high confidence be approved for a lower rate card that could save the consumer $X in interest expense with no increase in the monthly payment $Y due to a significant reduction in the APR Z %.

A wide variety of other suites 374 of modules operate with respect to other financial facets such as a facet N.

The financial data ingestion component 349 includes a variety of data source modules 352 each implemented as computational logic and configured to acquire, store, and provide information about financial parameters that indicate the state of the person's financial domain. The information can, among other things, identify, store, and provide data about financial transactions of the person.

A credit report module 376 fetches from credit bureau sources, stores, and provides information maintained by the credit bureau sources. The information can include balances on credit card accounts, bank accounts, mortgage balances, and other credit-related information. In addition to being provided to the allocation tactic generator, this information can be made available to a balance sheet module 378 and a future state estimate module 380.

The balance sheet module maintains a pro forma balance sheet for a person based on the credit report information, repeat transaction information, and other information. A repeat transaction identification module 382 analyzes information about categorized transactions to identify repeat transactions of the person. A transaction categorization module 384 analyzes historical financial transactions of the person and categorizes them, for example, by amount, or payee, or dates, or combinations of them. In some cases, the transaction categorization module also receives inputs from the consumer that aid in the categorization. For example, the person might respond to questions presented through a user interface of a device asking about the nature or timing of a particular transaction.

An historical financial transactions module 386 receives, stores, and provides data about known actual financial transactions such as a payment of a credit card bill, or a charge to a credit card for a purchase, or a mortgage payment, or a deposit in a savings account.

A ledger module 388 maintains a ledger of financial transactions of the person. The ledger stores and provides an itemized list of expected budget and cash flow transactions. Inputs to the ledger include known repeating transactions.

A future state estimating module 390 generates, stores, and provides predictions of the future state of a consumer's financial domain. The estimating module uses inputs from the credit report module, the pro forma balance sheet module, the ledger module, and user supplied inputs 392. The user supplied input module acquires, stores, and provides user input by interaction with a consumer in a user interface of a device.

In some implementations, the financial data ingestion component 349 acts as a server to make transaction information available through a publish/subscribe model 323 to other components and modules, such as the internal alerting component 344. The internal alerting component 344 includes a variety of computational logic modules that generate, store, and provide alerts or triggers to cause the resource allocation tactic generator to update its ranked list of resource allocation tactics. The computational logic of a transaction monitor module 396 subscribes to the service of the data ingestion component to monitor the occurrence of new financial transactions and applies rules to determine whether to raise an alert to trigger the updating of the ranked set of resource allocation tactics.

The computational logic of a credit report monitor module 398 similarly subscribes to the service of the data ingestion component to monitor changes in the credit report of a consumer, for example, a change in the credit rating, or a change in credit or bank accounts, or a change in mortgage accounts such as the paying off of a mortgage. The monitor applies rules to determine whether to raise an alert to trigger the updating of the ranked set of resource allocation tactics.

The computational logic of a time based scheduling module 400 uses rules based on time to decide when to issue an alert to trigger an updating of the ranked set of resource allocation tactics. For example, such a rule could cause an updating once a month, once a quarter, or once a year.

The computational logic of a user preferences module 402 acquires, stores, and acts on preference information provided by a user through a user interface of a device. The module can trigger an alert to update the ranked set of resource allocation tactics in response to a consumer request. The consumer request could be a one-time occurrence (“Tell me what I can do now to improve my financial state.”) or a periodic preference (“Let me know at the end of each month how I am doing with my credit card balances and what steps I ought to take.”) or a guiding principle for operation of the computational technology (“Ignore changes in my student loan balance in considering what financial assistance to give me.”).

FIGS. 2, 4, 5, and 6 contain certain reference numerals in boxes. These reference numerals are cross-references to corresponding technology elements illustrated in FIG. 10. FIG. 10 describes a platform that can be used for implementation of the computational technology described here and is a version of FIG. 1 presented in U.S. patent application Ser. No. 15/231,266, filed Aug. 8, 2018, and incorporated in its entirety by reference here.

Other implementations are also within the scope of the following claims.

1. An apparatus to coordinate an interrelationship and timing of (a) dynamic assessments of an overall state of a changing real-world system with (b) interactions occurring at one or more interaction times through a user interface on a device of the user, in order to alter the overall state of the real-world system based on the user interactions, the apparatus comprising
a hardware processor and a memory storing instructions executable by the processor, the instructions comprising computational components including an ingestion computational component, an assessment computational component, and a presentation computational component, the instructions being executable by the processor to cause coordination of the interrelationship of (a) with (b) by:
causing the ingestion computational component to ingest, at ingestion times, information representing states of facets of the real-world system, to maintain current information representing states of facets of the real-world system, the information being current relative to the times of interactions occurring through the user interface,
causing the assessment computational component to dynamically assess a current overall state of the real-world system, based on the current information representing states of the facets of the real-world system, as of one or more assessment times that are current relative to the times of the interactions occurring through the user interface, the dynamic assessment of the current overall state of the real-world system comprising weighting dynamic assessments of current states of respective facets of the real-world system to place different emphases on respective facets based on corresponding policy targets,
causing the presentation computational component to engage in the interactions at one or more interaction times by providing guidance representative of the assessed current overall state of the real-world system and receiving input associated with the assessed current overall state of the real-world system,
causing the assessment computational component to take account of received input in dynamically assessing the current overall state of the real-world system at assessment times that are subsequent to the interaction times,
causing the ingestion computational component to ingest the information at ingestion times that can be asynchronous relative to the assessment times and the interaction times.

2. The apparatus of claim 1 in which the information ingested by the ingestion computational component comprises values of state parameters.

3. The apparatus of claim 2 in which the values of the state parameters comprise values of transactions.

4. The apparatus of claim 2 in which the values of the state parameters comprise values of resources in accounts.

5. The apparatus of claim 1 in which the computational components include an ontology computational component, and the instructions are executable to cause the ontology computational component to apply an ontology to the ingested information.

6. The apparatus of claim 1 in which the instructions are executable to cause the assessment computational component to assess the current overall state of the real-world system in real time as information is ingested by the ingestion computational component.

7. The apparatus of claim 1 in which the real-world system comprises a financial domain of a user.

8. The apparatus of claim 1 in which the instructions are executable to cause the ingestion computational component to ingest at least one of user supplied information, credit bureau information, or transaction data.

9. The apparatus of claim 1 in which the computational components include a segmentation computational component, and the instructions are executable to cause the segmentation computational component to segment information ingested by the ingestion computational component according to demographic characteristics.

10. The apparatus of claim 1 in which the computational components include a policy computational component, and the instructions are executable to cause the policy computational component to provide policy targets associated with respective facets of the real-world system.

11. The apparatus of claim 1 in which the instructions are executable to cause the assessment computational component to apply valuation functions for respective facets of the real-world system.

12. The apparatus of claim 1 in which the instructions are executable to cause the assessment computational component to determine progress metrics for respective facets of the real-world system.

13. The apparatus of claim 1 in which the instructions are executable to cause the assessment computational component to dynamically assess current states of respective facets of the real-world system.

14. The apparatus of claim 13 in which the instructions are executable to cause the assessment computational component to dynamically assess the current overall state of the real-world system by weighting dynamic assessments of current states of respective facets.

15. The apparatus of claim 1 in which the instructions are executable to cause the assessment computational component to derive relative assessment values for the current overall state of the real-world system or for the current states of respective facets.

16. The apparatus of claim 15 in which the instructions are executable to cause the computational components to do one or a combination of two or more of the following:
perform allocations of resources available in the real-world system, prioritize allocations of resources, or provide interactions through the user interface.

17. The apparatus of claim 1 in which the instructions are executable by the presentation computational component to represent states of respective facets of the real-world system by interactions that include metaphorical elements.

18. The apparatus of claim 17 in which the instructions are executable to cause the assessment computational component to quantize the current states of each of the facets in a range of quantized buckets, and to cause the presentation computational component to provide interactions that include metaphorical elements that correspond to the quantized buckets.

19. The apparatus of claim 18 in which the metaphorical elements comprise suites of related graphical elements portrayed in successive states and the successive states correspond to the respective quantized buckets.

20. The apparatus of claim 1 in which the computational components include a prioritization computational component, and the instructions are executable to cause the prioritization computational component to prioritize possible moves associated with the current overall state of the real-world system.

21. The apparatus of claim 20 in which the computational components include a presentation computational component, and the instructions are executable to cause the presentation computational component to provide interactions that graphically illustrate the prioritization of the possible moves.

22. The apparatus of claim 21 in which the instructions are executable to cause the presentation computational component to provide interactions that graphically illustrate changes in the prioritization of the possible moves.

23. The apparatus of claim 1 in which the computational components include a presentation computational component to provide interactions that include financial guidance to a user.

24. (canceled)
